(19) United States
(12) Patent Application Publication
(10) Pub. No.: US 2009/0231233 A1
(43) Pub. Date: Sep. 17, 2009

(54) DIGITAL PHOTO ALBUM

(76) Inventor: Raymond A. Liberatore, Bentonville, AR (US)

Correspondence Address: MYERS WOLIN, LLC, 100 HEADQUARTERS PLAZA, North Tower, 6th Floor, MORRISTOWN, NJ, 07960-6834, US

(21) Appl. No.: 12/402,042

(22) Filed: Mar. 11, 2009

Related U.S. Application Data
(60) Provisional application No. 61/035,483, filed on Mar. 11, 2008.
(60) Provisional application No. 61/142,160, filed on Dec. 31, 2008.

(51) Int. Cl. G09G 5/00; G09G 3/36

(52) U.S. Cl. 345/1.3; 345/87

(57) ABSTRACT

A digital photo album includes, in one embodiment, a digital viewing unit for viewing digital media and a storage location for housing digital media viewable on the digital viewing unit.

### CROSS-REFERENCE TO RELATED APPLICATIONS

This application claims the benefit of U.S. Application 61/035,483, filed Mar. 11, 2008, and U.S. Application 61/142,160, filed Dec. 31, 2008, the contents of each being incorporated herein by reference.

### FIELD OF THE INVENTION

This invention generally relates to viewing digital photos, as for example viewing photos in a portable digital photo album, and more particularly in one embodiment to viewing photos with one or two display (such as LCD) screens or displays that is enclosed like a photo album book. Digital photos have been replacing film and printed photos for some time and the present disclosure allows the user to view all their digital photos and store them with convenience.

### BACKGROUND

When people take photos they view them on their computer, camera, laptop and cell phone etc. To capture these photos for safe keeping, the user has them printed, and/or saves the digital images to a disk or memory card. The user also saves the images on their electronic device, where they can edit the photos. To free memory on their memory card, the user backs-up the photos to CD's or other ways, and then takes more photos. The user has to find a place to put the digital print photos and where to keep their backup images for future use. There is need to overcome this digital viewing and storing method, in a simple, effective and efficient manner.

### SUMMARY OF THE INVENTION

A portable digital photo album is provided that allows a user to view and store photos, videos, and other digital media with convenience and in an environmentally friendly manner, anywhere and anytime. More preferably, the digital photo album disclosed herein is intended to replace the typical photo album, which has pages of printed photos that deteriorate and degrade in quality and are susceptible to tampering and removal over time. Over the years, a user could collect many albums that weight a lot and are subject to loss or destruction in the event of a fire, etc. The digital album of the present disclosure preferably includes at least one display unit for displaying digital media, and at least one storage location for storing digital media to be displayed on the at least one display unit.

It is intended that the digital photo album change the way digital photos are viewed. Typically, digital photos are viewed on a camera or cell phone, or immediately thereafter when offloaded to a computer or a backup device, or when printed. Over time, a user can generate many backup storage devices or memory cards containing hundreds or thousands of pictures. Using the digital album of the present disclosure, a user can safely and efficiently store all of these backup devices and memory cards and view collections of photos at a moment's notice and in a single portable location. Thus, a user avoids the problem of storing all photos in a single location, such as his/her computer, and risking the possibility of having the computer crash and losing all of the photos.

The digital photo album, in addition to storing and displaying of digital media, has other capabilities including graphics capabilities, memory card ports or memory expansion ports, a variety of input/output ports, the ability to make custom size photos, videos, etc., the ability to wirelessly interact with other devices, storage locations, etc., and other features and benefits as contemplated herein.

### BRIEF DESCRIPTION OF THE DRAWINGS

FIG. 1 shows one embodiment of a digital photo album in accordance with the present invention.

FIG. 2A is an embodiment of a dual-screen digital photo album.

FIG. 2B is an embodiment of a single screen digital photo album.

FIG. 3 is a partial view of the side of the digital photo album showing a port cover closed.

FIG. 4 is a close-up view of the side of FIG. 3 showing the port cover opened.

FIG. 4A is a magnified view of navigation buttons on the inside of a display screen.

FIG. 5 shows one embodiment of a possible arrangement of photos on a display screen.

FIG. 6 shows one embodiment of photos on one display screen and a video on another display screen.

FIG. 7 illustrates the use of a remote unit for controlling the viewing of photos.

FIG. 8 shows one embodiment of an edge view of a digital photo album.

FIG. 9 shows one embodiment of a digital photo album with storage.

FIG. 10 shows one embodiment of storage pages for various types of media.

FIG. 11 shows one embodiment of a digital photo album with a permanent memory board.

FIG. 12 shows one embodiment of a digital photo album with a removable memory board.

FIG. 13 shows one embodiment of a type of memory board usable with a digital photo album.

FIG. 14 shows various types of connection cables.

FIG. 15 shows one embodiment of a digital photo album connected to a digital camera via a cable.

FIG. 16 shows one embodiment of a memory board.

FIG. 17 shows one embodiment of a memory board.

FIG. 18 shows one embodiment of a CD or DVD drive and other ports that can connect to a digital photo album.

FIG. 19 shows one embodiment of a digital photo album.

FIG. 20 shows one embodiment of a digital photo album with a memory board is detached and further illustrates where the memory board slides into the digital photo album.

FIG. 21 shows one embodiment of a memory card used with a digital photo album.

FIG. 22 shows an alternative embodiment of a digital photo album with a storage tray.

FIG. 23 shows an alternative embodiment of a digital photo album with a storage cartridge.

FIG. 24 shows an alternative embodiment of a digital photo album with a removable cover.

FIG. 25 is a close-up view of one portion of FIG. 24 showing two memory cards or memory expansion cards that are connected to the photo album for memory or additional memory purposes.

FIGS. 26-30 illustrate various non-limiting embodiments, of a control scheme, screen menu options and operations, and various functionalities relating to use, storage, and input and output operations related to the digital album of the present invention.

FIG. 31 shows one embodiment of a digital photo viewing unit being inserted into a cover with storage to create a digital photo album.

FIG. 32 shows one embodiment of a digital photo album, with the digital photo viewing unit in the cover with storage.

FIG. 33 shows one embodiment of part of a digital photo album cover with a picture, art card insert area with a storage area with flap and/or cover.

FIG. 34 shows one embodiment of a digital photo album with storage on the left and a digital photo viewing unit in the digital photo album cover.

FIG. 35 shows one embodiment of a digital photo album being attached to a digital photo album cover.

FIG. 36 shows one embodiment of a digital photo album cover attached to the digital photo album.

FIG. 37 shows one embodiment of a digital photo album having one display screen on the right and a storage door and storage area on the left.

FIG. 38A shows one embodiment of a one display digital photo viewing unit inserted into a digital photo album cover with storage to create a digital photo album.

FIG. 38B shows FIG. 38A with the digital photo viewing unit inserted into the cover.

FIG. 39A shows one embodiment of a two display digital photo viewing unit inserted into a digital photo album cover with storage to create a digital photo album.

FIG. 39B shows FIG. 39A with the digital photo viewing units inserted into the cover.

FIG. 40 shows one embodiment of a digital photo album closed and the top layers show the digital photo album unit, while the bottom layer shows a zipper storage compartment.

FIG. 41 shows one embodiment of a two display digital photo viewing unit inserted onto a digital photo album cover to create a digital photo album.

FIG. 42 shows one embodiment of a two display digital photo viewing unit connected together and placed in a digital photo album cover to create a digital photo album.

FIG. 43A shows one embodiment of a two display digital photo viewing units that have mating hinge assembly built-in the inside part of the units connected together to make a digital photo album.

FIG. 43B shows one embodiment of a digital photo album with two display digital photo viewing units connected together.

FIG. 44A shows one embodiment of a dual-display digital photo viewing units frames that have mating hinge assembly built-in the inside part of the units that connect together to a hinge to make a digital photo album.

FIG. 44B shows the assembled display digital photo viewing units of FIG. 44A.

FIG. 45 shows one embodiment of a digital photo album and how a cover can be connected.

FIG. 46 shows one embodiment of a universal storage compartment or pocket for memory cards and similar devices.

FIG. 47 shows one embodiment of a universal storage compartment or pocket with a name tab or label.

FIG. 48 shows a top view of the universal storage compartment/pocket of FIG. 47.

FIG. 49 shows a side view of a universal storage compartment/pocket of FIG. 47.

FIG. 50 shows another view of a universal storage compartment/pocket of FIG. 47.

FIG. 51 shows another embodiment of the universal storage compartment/pocket.

FIG. 52 shows one embodiment of another version of a storage area with an individual universal storage compartment/pocket or a row of compartments/pockets with a storage door.

FIG. 53 shows one embodiment of a front view of a digital photo album and the many directions that a picture, art card or other document can be inserted in and out of the digital photo album.

FIG. 54 shows one embodiment of a digital photo album.

FIG. 55 shows one embodiment of a dual-display digital photo album.

FIG. 56 shows one embodiment of a single-display digital photo album.

FIG. 57 shows an exploded view of one embodiment of a digital photo album.

FIG. 58 shows one embodiment of a picture, etc., inserted in a digital photo album.

FIG. 59A shows one embodiment of a digital photo organizer with storage area for memory devices.

FIG. 59B shows one embodiment of a digital photo organizer with inserted picture.

FIG. 60 shows one embodiment of a digital photo album with built-in printer.

FIG. 61A shows one embodiment of a digital photo frame back with a storage area.

FIG. 61B shows one embodiment of a digital photo frame with a storage area on the side.

FIG. 62 shows a digital photo managing and storing unit.

FIG. 63 shows a wireless flow chart for a digital photo album and digital photo managing and storing unit.

FIG. 64 shows a wireless digital photo scanner that can send digital photos wirelessly to any location.

FIG. 65 shows one embodiment of a digital photo album having port openings and a memory compartment door open with access to an internal and removable memory card.

FIG. 66 shows one embodiment of a digital photo album with storage.

FIG. 67 shows one embodiment of a single screen digital photo album.

FIG. 68 shows one embodiment of a dual-screen digital photo album.

FIG. 69 shows one embodiment of a dual-screen digital photo album.

FIGS. 70A-70C show various methods for attaching a book cover to a digital photo album.

FIG. 71 shows one embodiment of a PCB with a removable memory slot that the memory card or similar device is accessible from outside of the unit.

FIG. 72 shows one embodiment of a parts view of a dual-screen digital photo album.

FIG. 73 shows one embodiment of a parts view of a single-screen digital photo album.

FIG. 74 shows one embodiment of a digital photo album holder for holding a digital photo album.

### DETAILED DESCRIPTION

The various embodiments of the digital photo album described herein are a convenient means to view pictures any time, any place with the convenience of looking at pictures alone, with family or friends in a typical photo album book concept. It can be any size or shape, can be formed from any material, have a variety of storage capacities of various media devices, and can associate with a variety of wireless devices. The digital photo album allows a user to view and store thousands of pictures in a built-in memory and the storage area all in one unit. It's like having hundreds of typical photo albums all in one digital photo album.

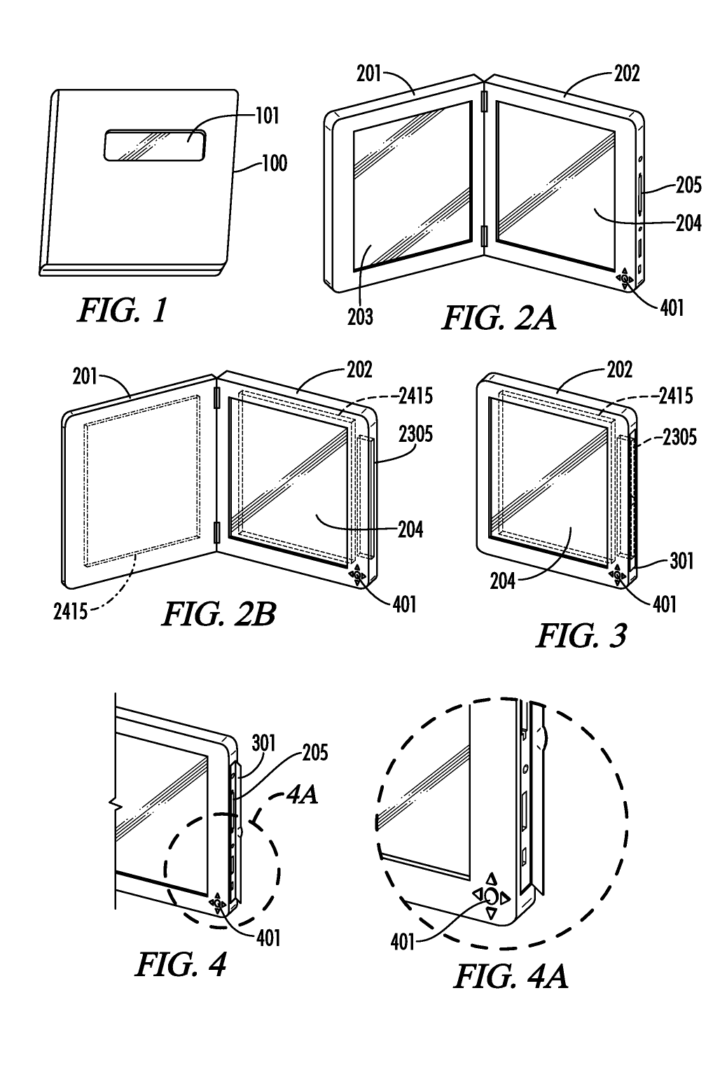

FIG. 1 illustrates one embodiment of a digital photo album 100 that can look like a typical paper photo album of any size when closed, but look like a laptop or notebook when open. FIG. 2 shows one embodiment of a digital photo album 200 comprising two display (such as LCD) screens, one to the left 203 and one to the right 204. While LCD screens will be used for purposes of explanation, it will be understood that other display technologies could be used quite satisfactorily. The digital photo album 200 can be any size or shape. It could look like a paper photo album with grooves around the middle section appearing to be pages. As shown in FIG. 1, the front cover could have a small screen 101, which the user could personalize or show what's inside, like a list of all disks, CDs, DVDs, flash drives, memory cards, and photos sent via wireless, Bluetooth or other means. The digital photo album can have locks or passwords to open the device or the storage area.

While one screen per side is shown in FIG. 2, it will be understood that more than one screen per side is possible. For example, one embodiment (not shown) could include more than one LCD screen per side, such as two or more per side. Each side could have multiple 4″×6″ LCD screens (preferably 2-6 screens per side), for example, 3″×5″ LCD screens, or others. It is preferably in the embodiment shown to have LCD screen sizes that are typical frame sizes 3×5, 4×6, and 8×10, wherein horizontally-aligned and vertically-aligned images can fit in these screen sizes. Of course, while an LCD in particular is described herein, it will be appreciated that other types of screens, such as CRT, plasma, TFT, Laservue™, projector display, (LED) light emitting diode display, OLED, BluRay, high definition and other display visual item whether now known or developed in the future and others, are contemplated, although obviously certain types of screens are more suitable to the type of application described herein.

In one embodiment, there is provided a set picture, for example, on the left screen 203 there can be a “set” or startup picture you see once you turn it on. This can be changed at anytime. These can be background images for the left and right sides of the unit and there should be background images included to put as the background. This can be found in a “Control Panel,” (described below) for example, and under Appearance and Personalization just as in a typical computer (Other non-limiting examples of user-accessible menus include Options, Slideshow, Arrange Photos, Caption Editing, Move/Delete Photos, Upload or Download, Export photos, Multi-Transitional Effects, Zoom-In Detail and Zoom-Out Detail, and any other term used for photos, and the like). In this area a user can change colors of the windows and the screen, for example. Also a theme area where a user can change the view of the certain areas of the photo album. Also contemplated is a screensaver mode whenever the digital photo album is not in use, and it can also be in low power mode when the screen saver is on. With a power saving mode, if there's no activity for, for example, five minutes, then, in one embodiment, the digital photo album would go to a 50% lighted screen, or other reduced power feature, for example. Then if there's no activity for five more minutes, for example, then the unit shuts off. If the user notices it's in power saving mode, the user can touch any button and it will return to 100% lighted screen, or any intensity set by the user. If the unit shuts off, then in one embodiment the user would have to turn the unit back on.

The digital photo album is preferably personalizable for arranging, organizing and/or positioning all photo images to the liking of the user. This can be done, for example, on the digital photo album itself or on a computer attached to the digital photo album. If done on a computer, for example, software could be provided to the user for designing and personalizing their own photo album. After downloading or using memory cards or picture cards, there can be an area where the user can select which size photos should appear and how many on each side of both screens (FIG. 2). After the user has decided, the user can click next with the middle “select” button (401; FIG. 4) and it will go straight to the “Arrange, Organize or Position” Photo area as will be described below. Using this the user can use the up and down arrows or curser pad, right and left click buttons like a laptop to navigate the photos, click them and it would move just that photo to drag them and click again to arrange them in the order desired for viewing. At any time the user can go back to these areas and change whichever album the user wants to view, one picture at a time or however many pictures at a time, and the sizes and number of pictures per view. The digital photo album as described herein can have an area for different photo albums with different pictures, such as, for example, “The Wedding album” or “Summer”. This can make it easy for people to view different albums all in one without just the choice of one album only.

The digital photo album as described herein could have a keyboard, touch screen keyboard or pad attached for photo album editing, positioning and operating the album.

Another embodiment as described herein is to have a typical digital photo frame converted to a digital photo album with cover and storage. A typical photo frame is placed on a wall or counter and viewed. A frame can be taken off the digital photo frame and it would not be called a digital photo frame it would be call a digital photo viewing unit. This unit can have any software, any operating functions, touch border interface, any touch screen technology, and converted to a digital photo album. A digital photo album cover with storage that is permanent or removable can be connected to the digital photo viewing unit or digital photo frame. This unit can have storage area for memory cards or similar devices on the cover or anywhere on the unit. A user can take off the frame of a digital photo frame and can be placed in a digital photo album cover with storage to make a convenient digital photo viewing and digital photo storing unit. This makes the digital photo frame portable, offers a convenient storing area for memory cards and similar devices and offers a cover for protection and a nice look to resemble a typical photo album.

In one embodiment, there is provided a printer port outlet so the digital album can be connected to a printer. If photos are in the built-in memory, the user can be able to download pictures to a memory card or any other electronic device that holds digital photos, so the user can take them to be printed, or put them on their laptop camera or other devices.

There is described herein a better way of viewing digital photos instead of using digital photo frames. Digital photo frames, sit on counters, tables or walls and you look thru the photo images in one LCD screen surrounded by a frame. It's not the same as looking thru pages in a typical photo album. In one embodiment, the present invention allows the user to look at several photos on a page in order, when they were taken on one, two or more LCD screens. The digital photo album can be set on a counter at an angle and viewed and it can also be placed straight across and have an easel built in the back to keep it from falling down. The user can use a remote (702; FIG. 7) to show his audience a slide show. The digital album can be used like a photo frame but can also be taken anywhere to be viewed like a typical photo album with much more convenience.

In one embodiment, the user would open the digital photo album like a laptop computer, for example, and it could have locks to open and close. There can be passwords, fingerprint or other biometrics, voice or other ways known now or known in the future to open the digital photo album and securely control access of the data enclosed. Once the user has the digital photo album opened, they can turn on the unit or it can automatically power up by virtue of the opening of the album if desired. FIGS. 4 and 4A show one embodiment of useful navigation buttons. With the unit on, the user can use the touch screen or buttons, or keys to move and choose up, down, select etc. 401. The user could see all photos listed and which number, letter, it is located in the storage area. If the digital album has internal memory, the user could choose the title of pictures, images, video, or text they wish to view. The user could also open up the storage area select the CD or memory card and insert the CD or memory card into a section where different XD, SD, memory card, USB, and other outlet ports are. The user could also hook up their camera, cell phone, computer etc. to get photos to view. The user could also send images via Bluetooth or other wireless technology known now or developed in the future.

In one embodiment, the two page LCD structure can be any size or shape and can be used to view books, magazines, manuals, home videos etc. The information can be sent via wireless means, downloaded or inserted CDs, flash drives or memory cards, etc. If there's a CD, memory card or wireless means of getting data to the album, then the data can be viewed page by page. It can be stored in storage area, for future use. It can play videos on one side and pictures or text on the other side or vice versa. This is a great way to view and store photos and home videos, data or text in one digital unit. The user could hook up their video camera and play home videos or via camera or cell phone, it can also be sent via Bluetooth technology or any wireless technology known now or developed in the future.

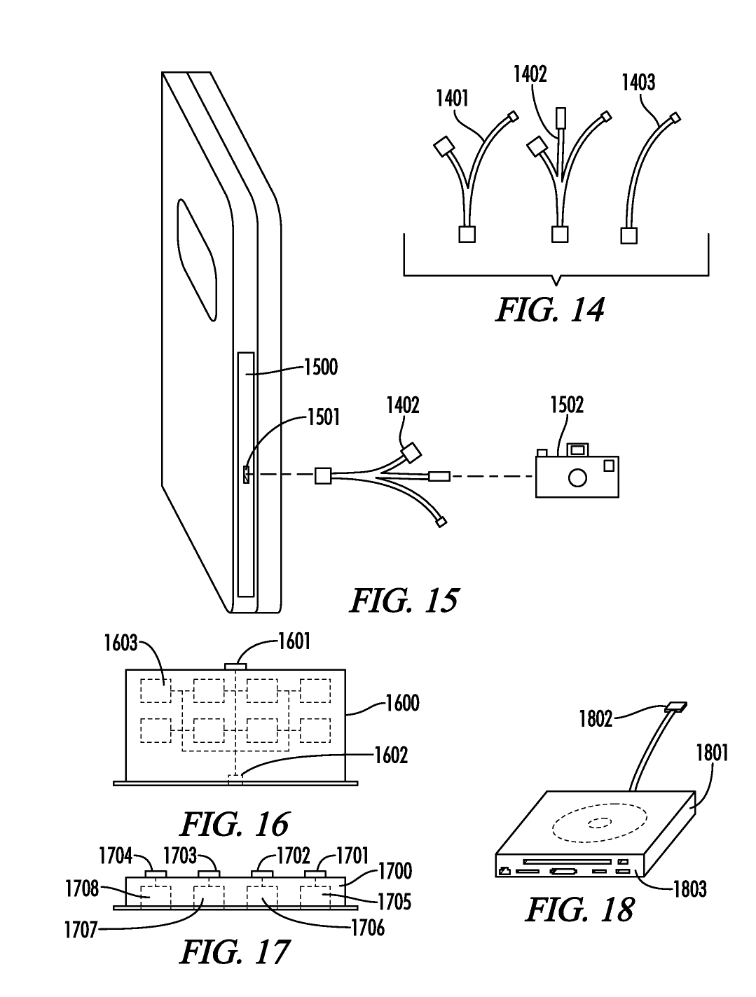

As shown in FIGS. 2 and 3, the digital photo album can have port openings 205 like SD/MMC, XD, CD, CF/MD, MS/MS duo, mini USB, USB Host, DC 9 v, and any others known now or known in the future. This area where the ports are located could be hidden in the side, top or bottom or anywhere. It can be exposed or have a cover 301 that can be pushed and it opens up and then it's exposed and push again and it closes. If the user pushes it closed, then the port area is not exposed. As shown in FIG. 15, the user could hook up their camera 1502 or computer to a port 1501 of the digital photo album via a cable 1402 to show images or to transfer images. As shown in FIG. 14, the digital photo album can be connected to a number of different devices using appropriate cables 1401-1403. These cables can have multiple connections such as USB, SD, XD, etc., and can be male or female.

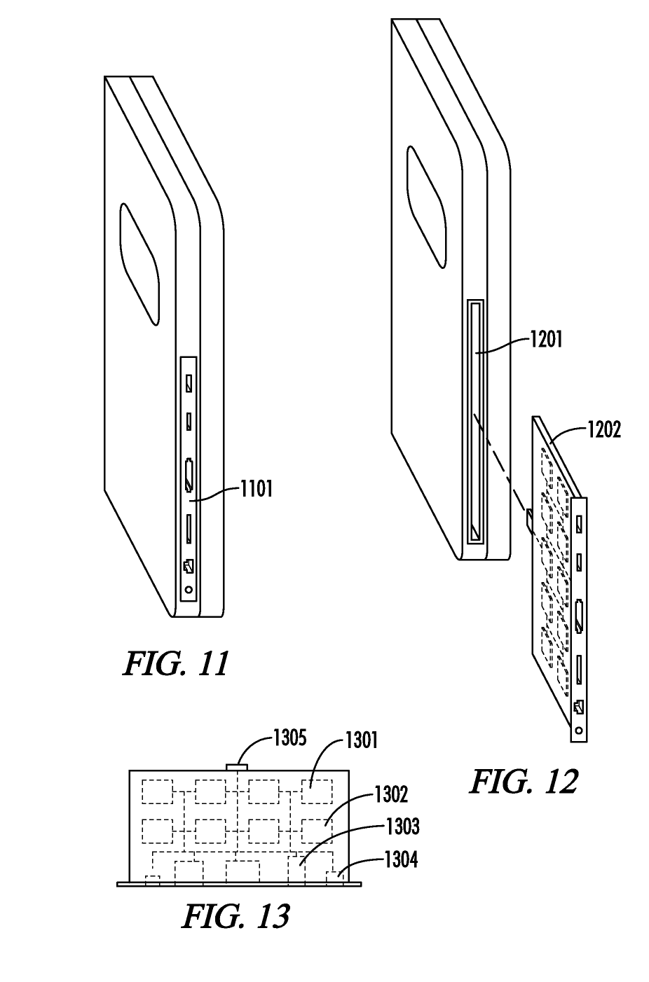

As shown in FIGS. 11-13, a photo memory board, having connection ports and media slots can be permanent 1101 or removable 1202. One can view the photos when the removable memory board 1202 is pushed into the slot 1201. The memory cards on the memory board can be permanent or removable. The memory card 1301 can be linked to any other types of memory cards 1302-1304, and the connector 1305 can be connected to a computer port or photo album. The memory board can be storage only or can be used to view photos and to provide storage. FIG. 16 shows memory board 1600 with an inlet slot 1602 and a connector 1601, with a number of memory cards 1603. FIG. 17 shows a single strip memory board, with a number of inlets 1705-1708 and a number of connectors 1701-1704.

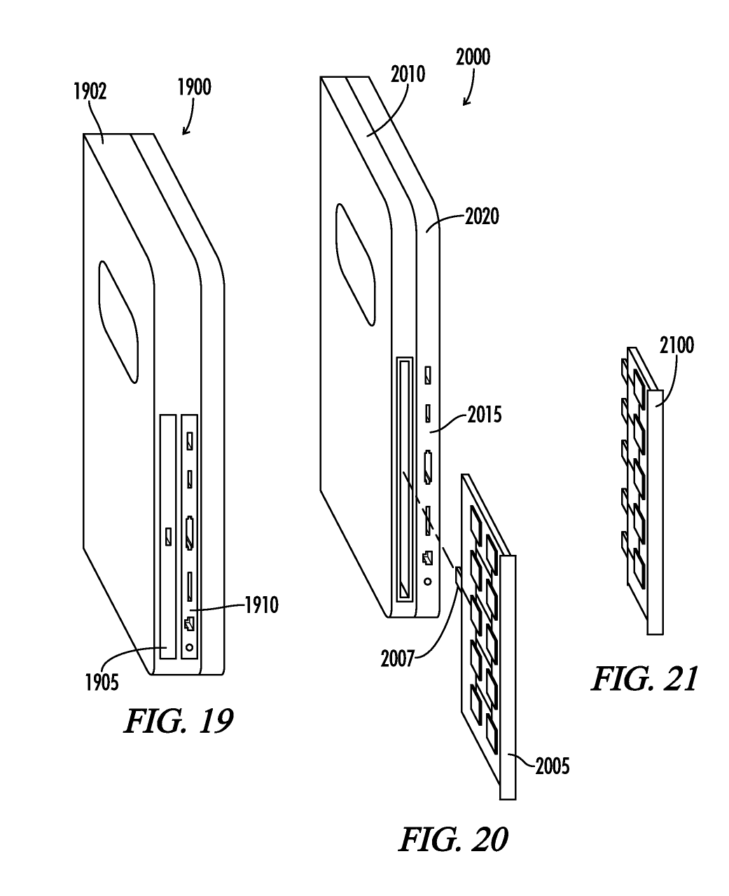

FIG. 18 shows that a CD/DVD drive 1801 can be connected to the album via the connector 1802. The CD drive will have an insert slot for CDs and can have other ports 1803 of media, such as USB, SD, XD, Flash Card, etc. FIG. 19 shows a CD/DVD/etc. drive 1905 adjacent a plurality of ports 1910 and associated on a front cover 1920 of a digital photo album 1900.

FIG. 20 shows a removable memory card board 2005 provided on a front cover 2010 of one embodiment of a digital photo album 2000, with a plurality of ports 2015 provided on a back cover 2020. The memory card board 2005 can have a master memory card 2007, or a memory card board 2100 (FIG. 21) could be utilized that just has a plurality of memory card locations. These memory cards or any type of photo capturing device known now or developed in the future can be removable or permanent. Once the tray is connected then the user can view photos and the tray provides a storage area. This tray can also be used for storage only.

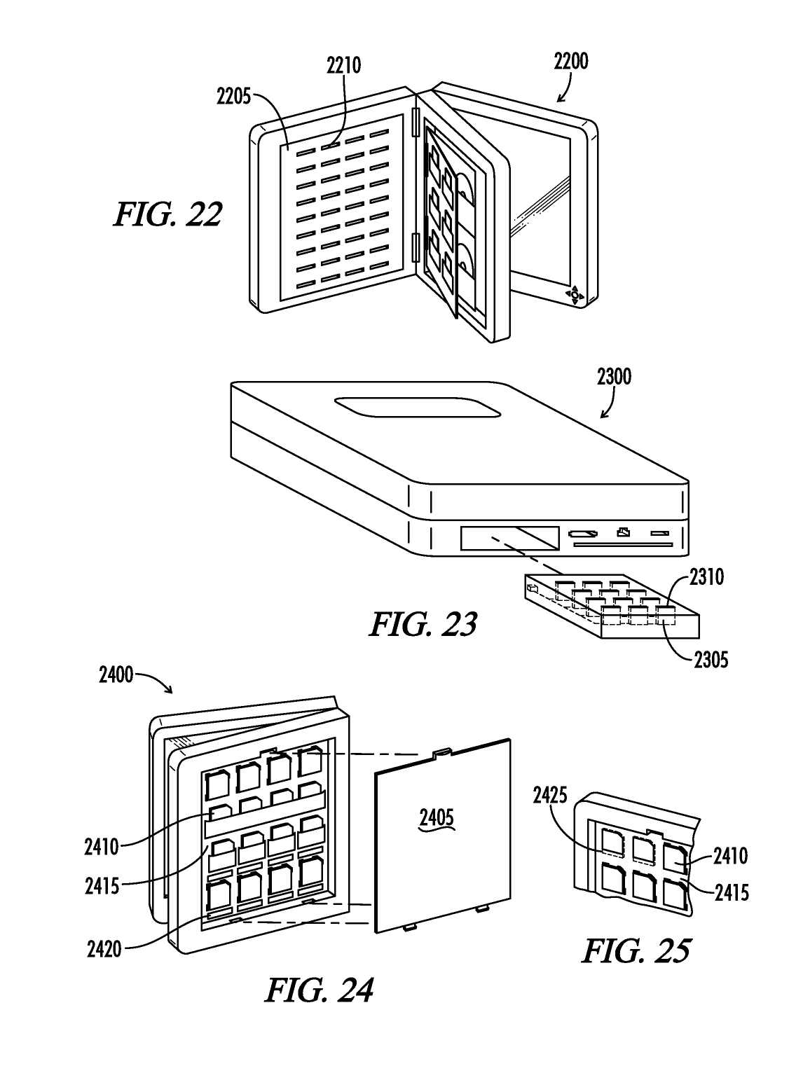

FIG. 22 illustrates one embodiment of a digital photo album 2200 comprising a tray 2205 of memory card slots 2210. FIG. 23 illustrates a digital photo album 2300 comprising a cartridge-type tray 2305 including a plurality of memory card locations 2310. In FIGS. 22 and 23, the tray 2205, 2305 either serves as a passive storage tray, whereby individual memory cards are removed and re-inserted into a card slot in another location on the digital photo album for individual card viewing, or the tray and each individual card location is electrically connected to the CPU for direct viewing of the contents of the individual cards while the cards are in the trays. In other words, the tray can function as a multi-card reader and processor for accessing information on multiple cards at the same time. The trays can provide storage only for memory cards or memory capturing devices known now or developed in the future. The trays 2205, 2305 may be removable for easy storage and transport, and the tray 2205 can be flush with the borders of the digital photo album page so that the tray does not interfere with other storage pages in the album. The tray 2305 can be further spring engaged with the photo album 2300 such that the user loads the tray 2305 with memory cards and then inserts the tray 2305 into the photo album 2300. Thereafter, in one embodiment, the user pushes the tray 2305 and it springs out of engagement with the album 2300 in preparation for loading, reloading and removing memory cards therefrom.

FIG. 24 shows one embodiment of a digital photo album 2400 including a removable front or back cover 2405 that reveals a plurality of memory cards 2410 secured to a support 2415 positioned adjacent such removable cover 2405. FIG. 25 shows an upper left corner of FIG. 24. The two upper left memory cards 2425 show memory cards or other digital photo capturing devices connected to the digital photo album for additional memory or to provide memory. In an alternative embodiment to FIG. 24, there could be provided one display (LCD) screen without a protective cover, but with a memory card storage on the back (see, for example, FIG. 61A, 61B) or inside the front cover or a slide out storage rack or tray anywhere on the digital album.

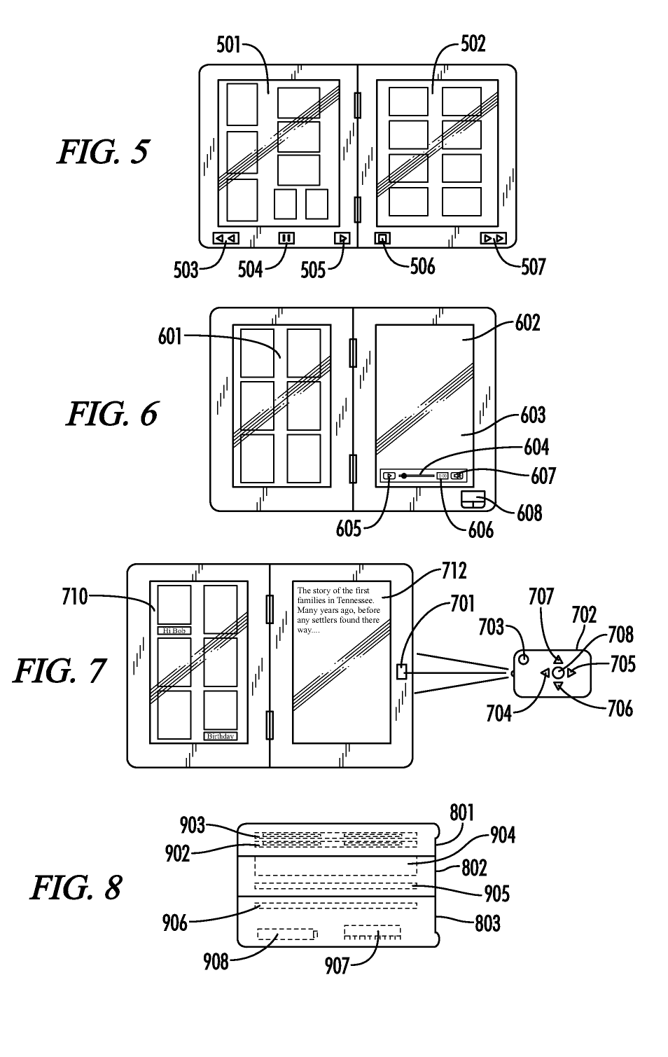

As shown in FIGS. 5 and 6, once the unit is on and the images are imported, then the digital photo album can show 3″×5″, 4″×6″, full size, any size, text, data, arrange, video 602 or a slide show of pictures, or the like on any size screen or multiple screens. Other variations and combinations are contemplated. The consumer can use touch screens, buttons or other ways to select the size (i.e., 3″×5″, 4″×6″, full size, etc.) or type (i.e., photo, home videos, text or slide shows) or the like. In one embodiment, the first page of the photos would appear to the left 501 and the second page of photos will appear to the right 502. A plurality of control buttons as shown in FIG. 5 such as back 503, pause 504, play 505, stop 506 and forward 507 could be provided to scroll through the pictures and pages of pictures as desired. Other control selectors in addition to those described above are contemplated. For example, the user could push the next page 507, and then the third page would appear on the left and the fourth page on the right, and so forth. The user could push previous page or back arrow 503 to scroll back. In another embodiment with a digital photo album with one LCD screen, the first page of the photos would appear on the screen. The user could push the next page and the second page would appear and so forth. The user could push previous page or back arrow to scroll back. The digital photo album can have capabilities where if the user touches the photo it can give you information about the photo or enlarge it to make the image bigger. This information can be entered prior to viewing through software or other ways on the digital photo album, computer, cell phone, camera or any device known now or developed in the future.

FIG. 6 illustrates one embodiment of a digital photo album including an LCD screen 601 for showing pictures and a screen 602 for showing video, with the screen 602 including a full size video screen 603 and a progress bar 604 including a play button 605, a counter 606 and a volume control 607. Other control functionality may be provided instead of or in addition to that which is described herein.

A CPU (Central Processing Unit) is provided that can, among other things, sort photos per page, horizontal or vertical photos. Depending on the size of the LCD screen or screens, the CPU can determine how many photos will fit per page. Once selected, then the CPU can put the photos in order via 3″×5″, 4″×6″, full size, etc., and/or as determined by the user. Of course, the CPU will also control the primary processing functions of the digital photo album. When the user is done enjoying the photos, they can put the CD or memory card away or disconnect the camera, or Bluetooth (any wireless way), then they can put in more CDs memory cards, flash drives etc., and start the process over. To select pages, turn pages or operate the album, there could be a remote 702 (FIG. 7), buttons or other ways to operate the unit. The remote 702 could have, for example, a power button 703, up 704, down 705, previous page or back 706, next page or forward 707 and select 708, which interact with the CPU to enhance the viewing experience.

It is preferable in the digital photo album embodiments described herein to have touch screen technology to operate the digital photo album. Aside from navigation and providing information about the photos, the user can manipulate photos using touch. For example, if the user touches the photo, in one embodiment, it enlarges the photo and to full screen for example. There are many ways to do this, if the user touches the photo once, it gives information about the photo, and if the user touches it again, it enlarges the photo, and if the user touches the photo a third time then it goes back to the original photo size. Of course, the manner in which photos are identified, viewed, manipulated, etc., can be established through the selection of preferences in a Control Menu. The display screens could have touch screen, touch border interface and or buttons and have icons all over the page. The icons can show folders like photo folders, albums, edit, import photos, export photos, music, video, and control panel, plus any more that can be related in viewing photos. If the user clicked photo folders, all the photo folders would appear, and then the user can click and open a photo folder. The photo folders can be labeled by the user, so they will know what photos are in a particular folder. The user could push it and all the photos will show up and you select page by page. Many more ways of sorting and accessing are available, but this is an example. Software can be provided, so the user can install it on the computer, edit, arrange, and classify, name all photos, then save it to a CD, or memory card, so it's ready for the digital photo album. Or it can be sent via Bluetooth or any wireless technology or any photo transfer method. Or software can be provided in the digital photo album or portfolio when you purchase it to accomplish the same.

In accordance with another aspect of the present invention, the digital photo album could have a hard drive, or RAM for built in memory. Consumers could store photos on this digital photo album and select the title of photo's you want to see, then they would be ready to view. Another embodiment is to have a storage area for automatically storing photos, so a user will not lose them in case the digital photo album crashes. This digital photo album can have a storage area for storing a back-up hard drives, or the storage area can be for storing memory cards, flash drives and CD's etc. In one embodiment, the digital photo album can be without a storage area as well.

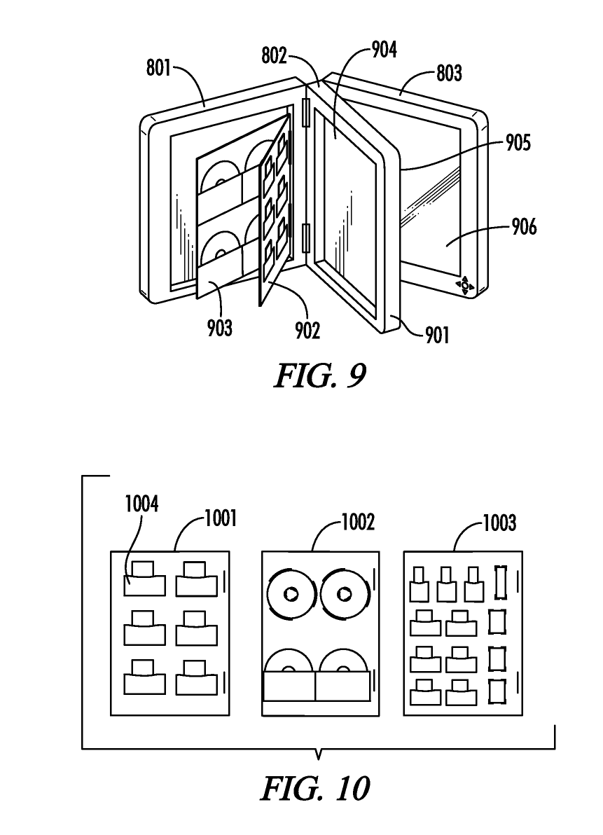

As shown in FIGS. 8-10, a built-in storage area (801) is provided for hard drives, CD's, flash drive, memory cards and other photo capturing devices known now or in the future. This allows the consumer to have thousands of photos ready to view at a moments notice. In one embodiment, there will be three sections 801-803, comprising a storage section 801 for storing various pages of media 902, 903, a central section 802 comprising open storage 904 and a screen 905, and another display section 803 including a screen 906 and internals including, but not limited to, a CPU 907, battery 908 and the like. The battery 908 can be replaced from the side, inside left panel or the bottom of the digital photo album, for example. The batteries can be AA, AA rechargeable, removable or permanent batteries. The batteries can be similar to laptop, notebook batteries or any type of battery known now or developed in the future. These can be built in or be removable and have a charging cord to plug into the digital album for charging the battery. The middle section 802 can have a lock that controls access to the first and/or third sections 801, 803 selectively and respectively. The storage area could have sheets (1001-1003) in a three-ring binder format, for example, with sections or inserts made for CD's, flash drive or memory cards and other memory devices. The storage area is a safer alternative than storing images on the computer for long periods of time or other ways which digital images can be lost or not found. It is also contemplated to have an external hard drive that is specifically designed for the digital photo album and for digital photos and videos.

The storage area sleeves, individual compartments, group compartments, pockets or inserts can have areas 1004 where a user can personalize the insert area or other ways describing the photos that are in CD, flash drive or memory card. Each sleeve is custom made to fit CD's, memory cards, flash drives, compact flash etc. All digital photo album drawings, specification or embodiments mentioned in this application can have any type of memory card, flash drive or any type known for digital photos now or developed in the future to be used with or can be stored in the storage area. It can be built into the storage area like a 3 ring binder or other ways. The user can add sleeves or remove them. The storage area can have memory expansion cards, back up hard drives for digital images where a user can add or remove them as well. There can be an area marked or labeled, “Back-Up,” for example, where the user can keep a back-up of the built-in memory in case there is any problems with the digital photo album memory. In one embodiment, the digital photo album could ask the user during use or changing any memory, if the user would like to back-up the built-in memory. The memory card or device can equal the built-in memory or it can use one more to equal the built-in memory. The digital photo album can identify the memory card or device and let the user know or the user can find out how much memory is left on the album or the memory card or device. This will help the user know how much memory is left on the digital photo album and if they want to add photos, then they might have to export and remove some photos or folders to make room.

In the storage area, there can be provided a back-up or auto back-up devices. In one embodiment, the storage area can be on the inside left panel, cover or anywhere. It can have a storage door with or without a place to insert a picture. The storage area can have individual or group pockets or individual or group compartments. It can also have rows of storage. These storage areas can have flaps or covers to hold the memory cards in place so they don't move around. These storage areas can have a form fit, which fits the exact size of the memory card, flash drive, compact flash or any known now or developed in the future. The storage areas can have universal pockets, sleeves or compartments that can fit any type memory card, flash drive, compact flash or any known now or developed in the future. The storage doors can be attached via magnets, for example, push in for open, and push in for lock, have guide arms and holes or any type of opening and closing method known now or developed in the future. On the inside of the storage door it can have padding and there can be areas of padding that stick out farther than other areas so it can hold the memory card or devices in place so they don't move around. The padding aids in protecting the memory card or devices.

In other embodiments as described below, a storage area can have a universal pocket or storage area that fits any size memory card, flash drive, compact flash or any known now or developed in the future. This area can have single or individual compartments that can fit one, two or more memory cards or devices and also have group or rows of compartments. The inside area can have rubber or foam type material, so it can fit all size memory card or devices and also protect them. The softer material expands and retracts and that's how it holds the devices in place, like a compression fit. The universal compartments can be attached by snap or any possible fastening method. The compartment area can have legs or extenders that go into the rubber or foam material to hold it in place or it can have adhesive. There can be label areas where the user can add and remove labels so the user can identify what memory card or device is in the storage area. The label area can have slots where it holds a paper or any material label in place. The label can be an adhesive label or not. In another embodiment, leather or any type of material cover can have storage areas. The storage area can be on the inside left or right side, front or back. The storage areas can be enclosed by a flap or zipper. If the flap is used, a hook and loop-type fastener (such as Velcro®) can be used to open and close the area or any type of opening and closing method. There can be a zipper compartment within the storage area and the zipper is used to open and close the compartment or any other way. Inside the storage areas can have individual, group pockets or compartments. The pockets or compartments can fit one or several memory card or devices known now or developed in the future. There can be stitching separating the pockets or compartments. There can be padding in or around these compartments and any where on the storage flaps or anywhere in the storage areas. The digital photo album cover can have padding or any type of material to protect and make it feel comfortable and soft to the touch. This storage area can be fire and water proof. The digital photo album as described herein allows consumers a safer way to save photos without the chance of computer crashes or losing their digital photos and not being able to find them.

Another embodiment of the present invention is to have a digital photo album storage unit only without display screens. This unit can hold hard drives of photos, back-up photo devices and can be sent by wireless or be downloaded and it can hold CD's, flash drives, memory cards and other memory devices. This could be any size or shape or could look like an album. This could also be fire and waterproof with locks. This will protect all your digital photo memories. This is another safe location to keep all your digital images in one location. This storage unit can have back up devices and wireless technology to send photos anywhere, any place and any time. It can be operated by cell phone, laptop, computer or any wireless or non wireless means known now or developed in the future.

As shown in FIG. 7, a remote (702) is provided to operate the digital photo album, to select pages, turn pages or operate the album, for example. There can be a convenient safe place to store the remote, such as in one of the photo album covers separate from or adjacent storage areas for storage medium such as disks, cards and the like. The remote can also have a LCD screen to view every operating function and contents of the digital photo album. The remote can also have link technology, wireless technology (701) and to operate all functions of the digital photo album. The LCD screen on the remote can have touch screen technology or any type known now or developed in the future. It also can have a password, fingerprint or the like, to operate and turn on. In a further embodiment, the digital photo album has an AV port to connect to the TV or similar screens or any similar type of TV connection known now or developed in the future. Instead of watching everything on the digital photo album itself, the user would be watching everything that can be viewed or heard on the digital photo album on the TV or similar type of screens.

FIG. 7 also illustrates a digital photo and text portfolio for businesses or others to show photos 710, videos, data and text 712 to customers etc. This portfolio can be used for boardrooms or presentations, everyone present can have the same type of portfolio linked together. This digital album can be used as a portfolio in a board room where everyone has one to view and the person giving the presentation can have a master remote to link all digital portfolio albums to have the same page viewed by everyone, instead of using paper. The user would continue to switch pages with text, photos and video etc.

Yet another embodiment of the present invention is to have Bluetooth technology, broadcasting, internet capabilities and other wireless, wireless router technology and capabilities known now and in the future. The user can send all their photos thru Bluetooth, internet and other wireless technology known now and developed in the future via computers, cell phones, cameras, and other electronic devices known now or developed in the future. The images could be stored in the storage area of digital photo album, so they would not get lost and can be viewed any time they want. The digital images can be viewed on the digital photo album only, for example, without storing the images on the digital photo album. Broadcasting can be used through the digital photo album. The user can send photos, albums, slideshows, videos etc to other digital photo albums anywhere in the world through wireless technology, internet and any other way known now or in the future. In one embodiment, the digital photo album has a computer, laptop, and notebook similarities except the digital photo album would be mainly for viewing, sending, copying, storing and editing digital photos. The digital photo album can have printer ports as well. Yet another embodiment is to send photos via the digital album to stores to have the images printed. As long as the digital photo album has connectivity with the internet, software can be implemented that will allow a user to select pictures directly on the digital photo album and have the same sent to an offsite facility for printing and delivery.

Yet another embodiment is to have an area to store music or attach to an iPod® or other digital media player, for example, so the user can listen to home videos or music. It can have speakers. The album can have a built in keyboard, or touch screen to edit, name photos, add text, etc. Furthermore, it can have built-in scanners or plug-in for scanners (FIG. 64), and have scanning technology so that old photos or photos that are in typical photo albums now can be scanned into the digital photo album or done via computer or ways known now or developed in the future and then be saved and inserted or sent to the digital photo album for viewing.

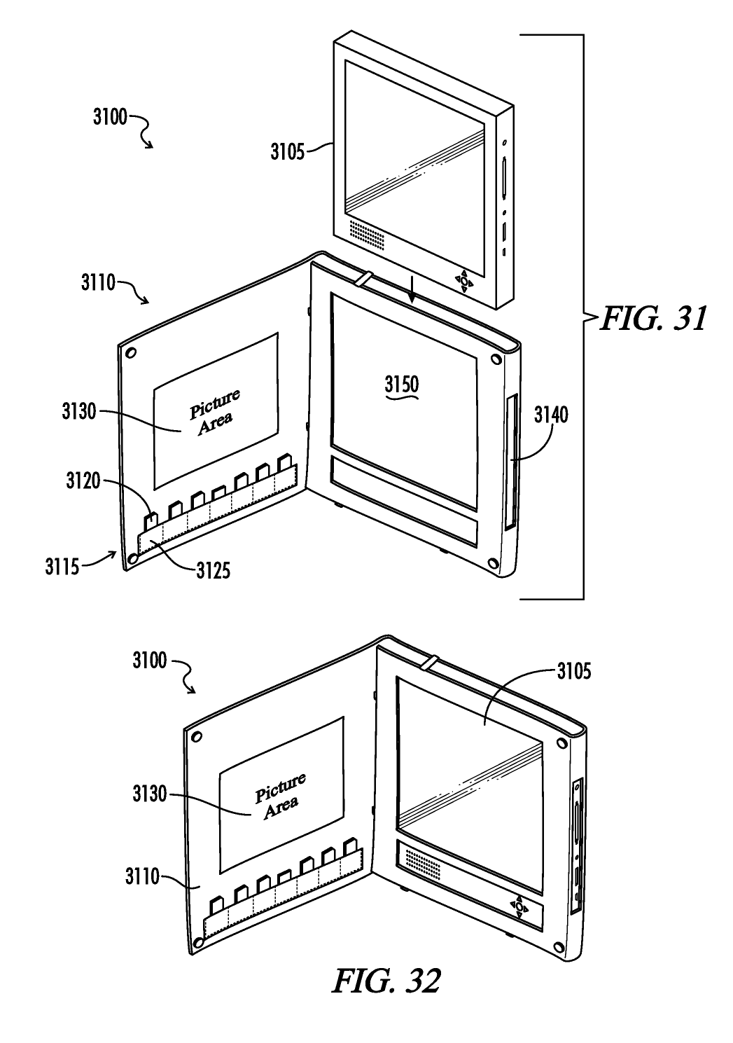

In a further embodiment, the digital album can have covers, skins, leather, colors, designs, fabrics and many more. These could be added on the outside to make it more special and personalized and could be sold separately. A cover can be made of any material and can be permanent or removable. The cover can have padding inside to give a softer feel. The cover can have a storage area anywhere on the cover. The cover can have place where the user can insert a picture that will show on the outside of the album or inside the cover. The picture can have plastic protecting the picture and have a plastic sleeve to protect and aid in taking in and out the picture from the album. The picture and sleeve can be placed in between the cover and the inside left body of the digital photo album. A portion of the sleeve can stick out so the user can easily pull the sleeve out from the album and interchange pictures or word art like “Memories” etc. One embodiment of a digital photo album and cover with storage is shown in FIGS. 31-34. Other non-limiting embodiments are shown in FIGS. 53, 54, 56, 58, and 59B, for example.

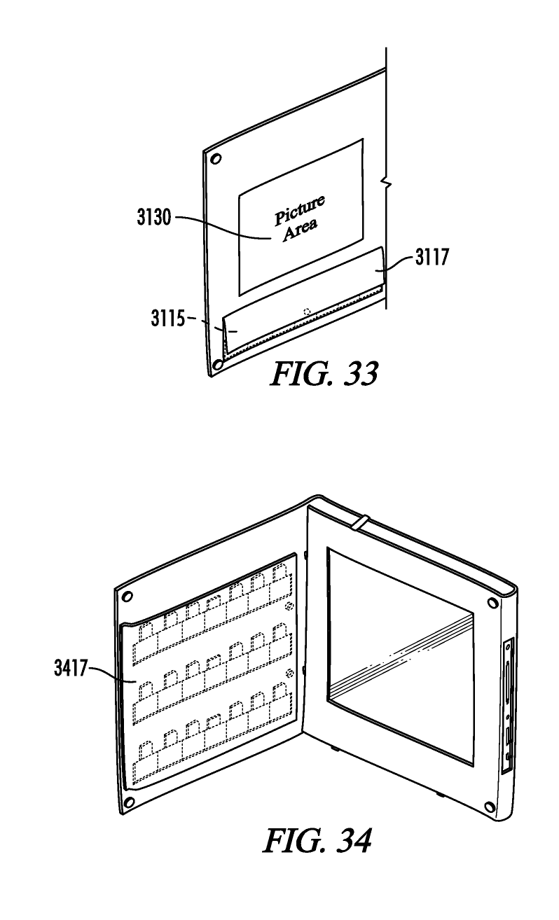

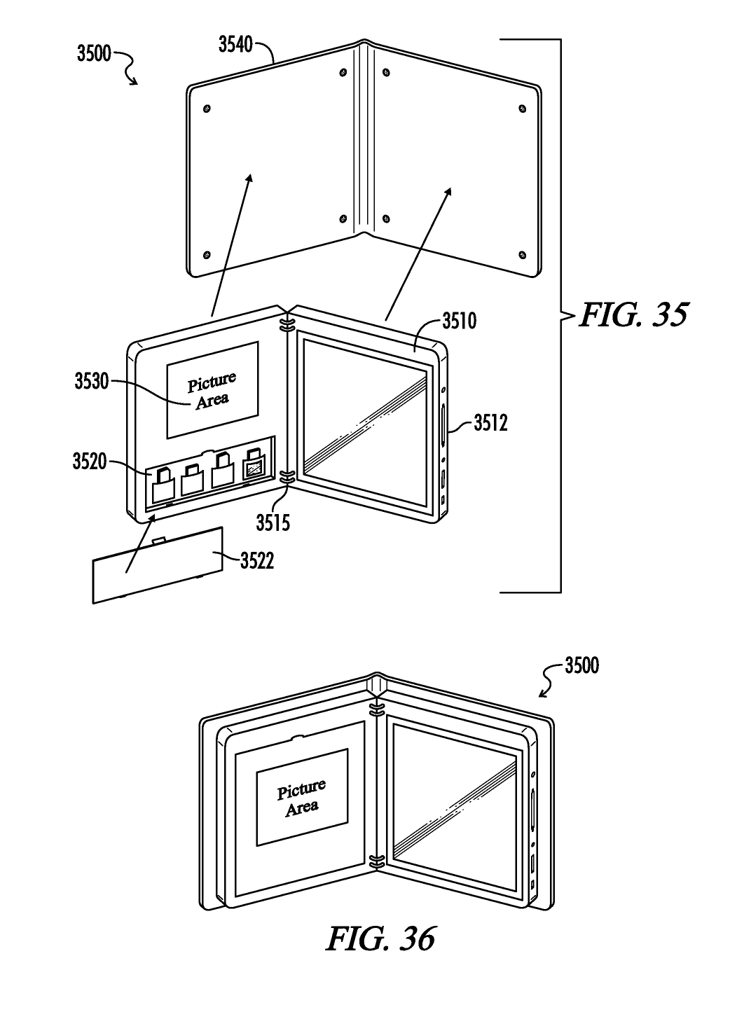

FIG. 31 illustrates one embodiment of a digital photo album 3100 comprising a digital photo viewing unit 3105, which can further comprise a digital photo frame for example, insertable into a cover 3110. In other words, any digital photo viewing unit 3105, which allows you to view digital photos etc., can slide into the cover 3110 from any side, or top to create a digital photo album 3100. The cover 3110 can be any type of material. The cover can have padding, so it protects and is soft to the touch. A storage area 3115 for memory cards 3120, memory sticks, flash drives, etc. and any type known now or developed in the future, can be placed anywhere within the cover 3110. There can be a storage area 3115, compartments or pouches 3125 can be in the inside left cover as shown in FIG. 31-34. FIG. 32 shows the digital photo viewing unit 3105 assembled into the cover 3110. In FIG. 33, the storage area 3115 has a flap or cover 3117 which covers the memory cards and similar devices 3120. In the embodiment of FIG. 34, a flap 3417 or cover wraps from left to right. The flap or cover can be any direction, secured via any means such as snap, button, hook and loop or the like. The embodiment of FIGS. 31-33 further comprises a picture area 3130 where the user can slide a printed picture or any type of paper or even CDs for example. This area 3130 can have a plastic cover protecting the picture. The picture area 3130 can also be a LCD screen if desired. This picture area can have an opening to the front of the album, so the user can turn a picture around and insert the picture in the picture area 3130 and then the picture would be visible to the front of the digital photo album cover 3110. This pouch can have a border around it to resemble a photo frame. There can be magnets, or any type of closure to help keep the album closed when not in use and closed. FIGS. 31, 32 and 34 illustrate a cutout or opening 3140 provided in the cover 3110 to enable access to ports on the digital viewing unit 3105 while such unit 3105 is housed within the cover 3110. Also shown is a securing feature or strap 3150, which can be an elastic type of material to be stretched so the digital photo viewing unit 3105 can slide into the cover 3110, then the strap 3150 elastic will hold the unit 3105 in place. The strap 3150 may be elastic and simply stretches out of the way during insertion and removal of the viewing unit 3105, or it may be fastened using other means such as snap, button, hook and loop or the like.

The embodiment of FIGS. 31-34 illustrates one way to convert an existing digital viewing unit, such as a digital frame or a tablet-style computer, into a digital photo album with onsite storage of media. Thus, the cover 3110 with storage 3115 could be vended separately and specifically dimensioned to accommodate digital viewing units currently on the market for example. This could be provided at the point of purchase for the digital viewing unit, or it could be done through an online system where a user would input the dimensions of the digital viewing unit, or the brand and size of the same, in order to obtain an appropriately-sized cover with storage. In other words, the dimensions, model, brand, etc., may dictate the size of the screen opening 3150 (FIG. 31), the location of the port opening 3140, and the overall dimensions of the combination unit 3100. Of course, while a storage area 3115 is certainly desirable, the cover 3110 may be vended without the same if it is only desired to convert an existing digital viewing unit into a covered album style.

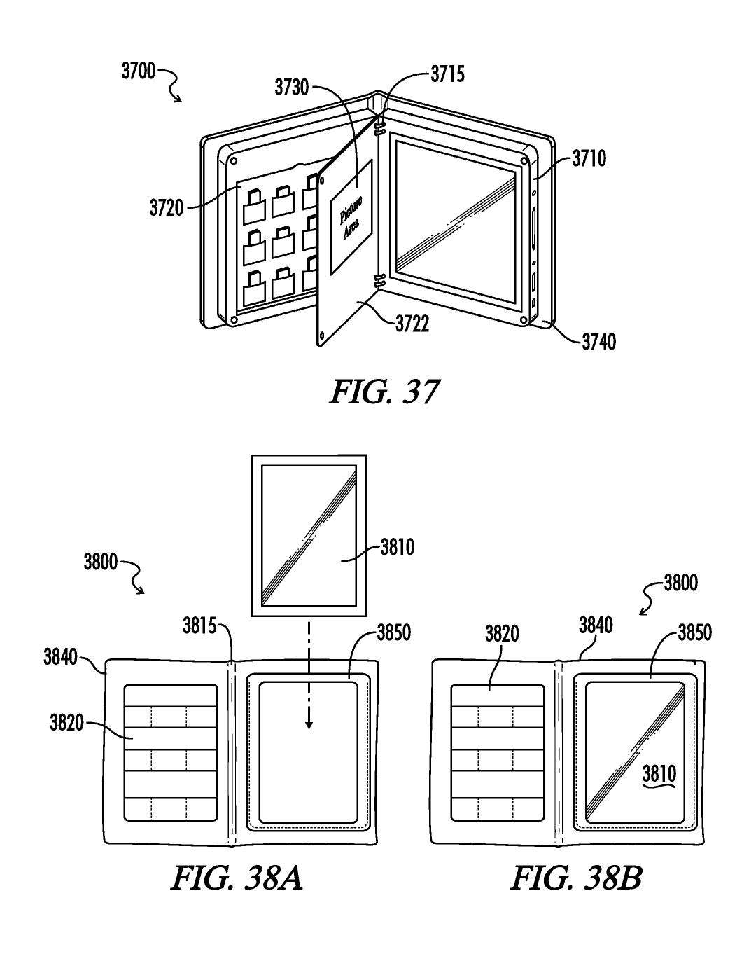

FIGS. 35-36 illustrates an alternative embodiment of a digital photo album 3500 comprising a digital photo viewing unit 3510 with ports 3512 connected to a storage area 3520 and picture area 3530, which is collectively connected to a cover 3540. The unit 3510 and storage area 3520 can be attached by hinge 3515 or any way known now or developed in the future. The storage area 3520, picture area 3530 or ports 3512 can be located anywhere. The unit 3510 and storage areas can be attached to the cover 3540 by hinge or any possible way known now or developed in the future. The cover can be made of any type of material and can have a picture area or a LCD area for the front of the cover as been described above. FIG. 36 illustrates the assembly of the elements shown in FIG. 35. In FIG. 35, there is shown a storage door 3522, which can be located anywhere. FIG. 37 illustrates a digital photo album 3700 similar to the album of FIGS. 35-36, but with a storage area 3720 hinged to a viewing unit 3710 and connected to a cover 3740, with a storage door 3722 for covering the storage area 3720 and that opens from the hinge 3715. The storage door 3722 can be attached or removable, and can be further provided with a picture area 3730, for example. Other ways of attaching the storage door 3722, such as magnets, catches, buttons, snaps, etc., are contemplated.

FIG. 38A shows one embodiment of a digital photo album 3800 comprised of a digital viewing unit 3810 and storage area 3820 where the unit 3810 can attach to the cover 3840 by sliding it into a sleeve or pouch 3850 in the cover 3840. It can be placed into this cover by any direction, can be permanent or removable and can be attached anyway possible known now or developed in the future. FIG. 38B shows the assembled album 3800, with a storage area 3820 on the left and the viewing unit 3810 on the right, but of course these items can be arranged in any order and in any location. FIGS. 38A and 38B both show a touch screen or touch border interface, however it can comprise buttons or other functioning methods. A loose material, curved area or flexible area is shown in the binding area 3815 to aid in the opening and closing of the album 3800 and to make it appear like an album book. All binding areas in this application can look like a book, photo album, scrap books etc.

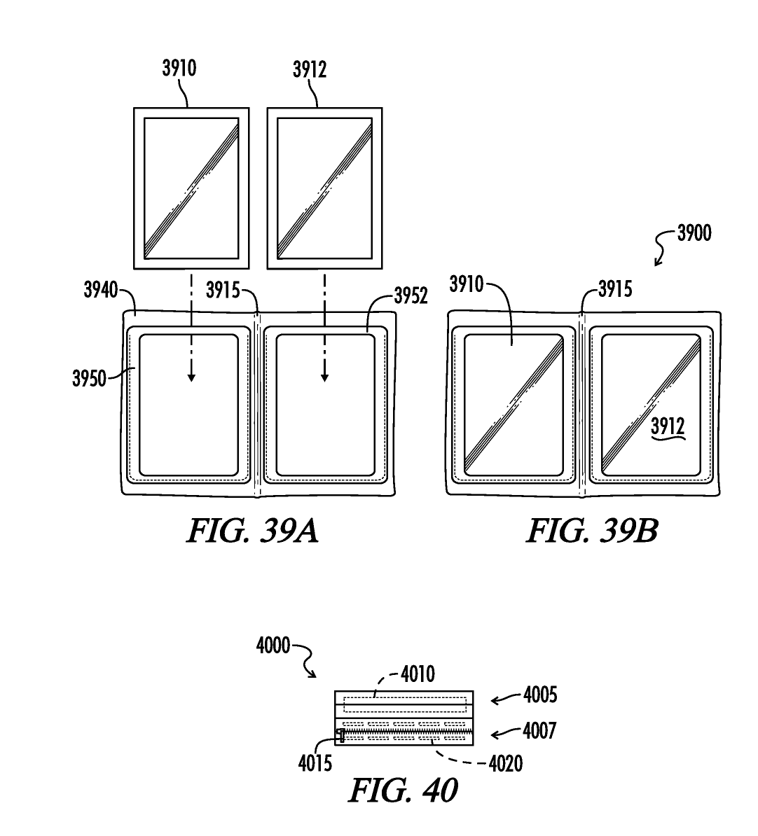

FIGS. 39A and 39B show a digital photo album 3900 comprised of two digital viewing units 3910, 3912 inserted into sleeves or pockets 3950, 3952 and housed in a cover 3940. Even though the units 3910, 3912 appear to be separate, the units can be attached via wire or any electronic means to connect the two units together so they can work together in unison. A storage area 3920 can be located on the back of the digital photo album 3900 or there can be side trays or side, top, or bottom insert storage areas as desired. The binding area 3915 is shown between the units and it can have a cover to hide the wire connections between the two units 3910, 3912.

FIG. 40 shows a bottom edge view of an alternative embodiment of a digital photo album 4000 in a closed orientation. The top section 4005 is where the digital viewing unit 4010 is located. The bottom section 4007 shows the storage area 4020 with a zipper 4015 for opening and closing the storage area. Anywhere the storage area is located, there can be a zipper storage compartment for opening and closing the storage area. The top section and bottom section can be hinged together as discussed herein, or attached using other means.

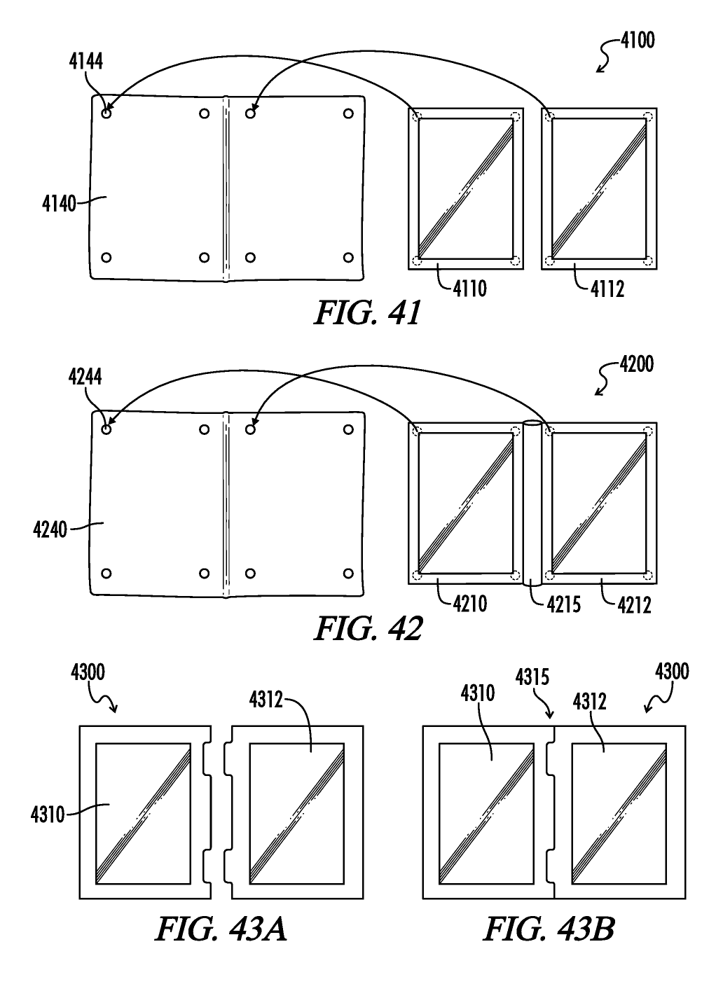

FIG. 41 shows an alternative embodiment of a digital photo album 4100 comprised of two separate digital viewing units 4110, 4112, attached to a cover 4140 via removable fastener connections 4144 such as hook and loop, adhesive, snap or screw or other known ways. The units 4110, 4112 can be connected together via wire or other electronic means as previously described, and storage areas (not shown) can be provided on the back of the cover in a manner as previously described.

FIG. 42 shows an alternative embodiment of a digital photo album 4200 comprised of two digital viewing units 4210, 4212 connected to a hinge 4215 and then the hinged unit is attached to the cover 4240 via removable fastener connections 4244 such as hook and loop, adhesive, snap or screw or other known ways. The units 4210, 4212 can be connected together via wire or other electronic means hidden with the hinge 4215 as previously described, and storage areas (not shown) can be provided on the back of the cover in a manner as previously described.

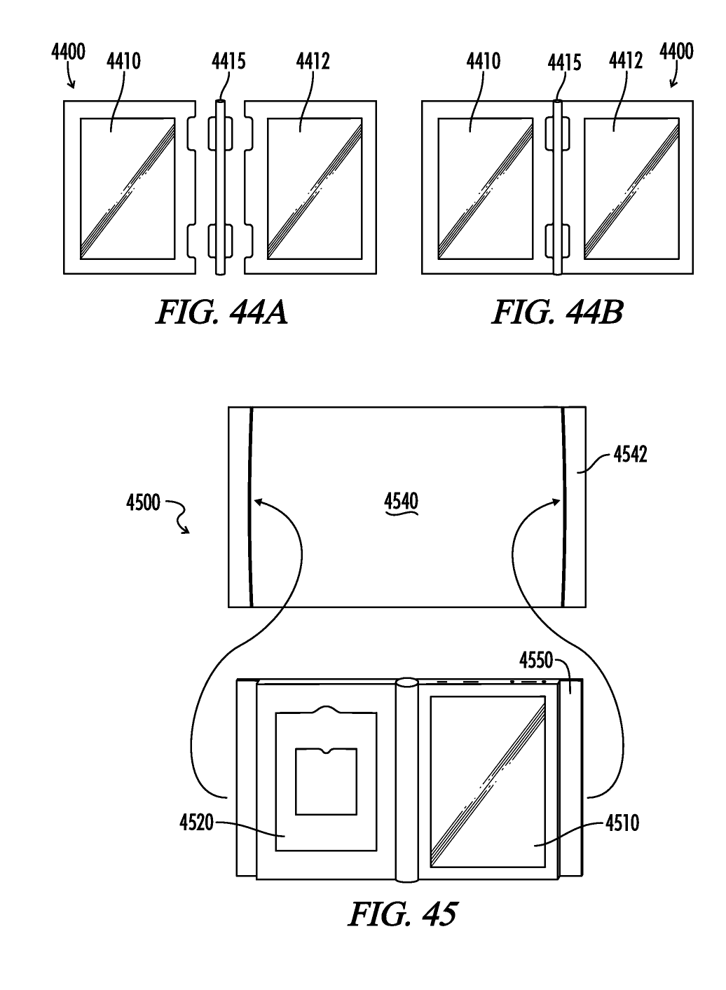

FIGS. 43A and 43B show an alternative embodiment of a digital photo album 4300 comprised of two digital viewing units 4310, 4312, where the inside right side of the first display unit 4310 and the inside left side of the second display unit 4312 mate to form a built-in hinge 4315, so when the units are connected with a hinge pin, it can open and close like a book. While two viewing units are shown, it will be appreciated that either viewing unit can be substituted with a media storage area, and/or additional storage areas can be provided on the back of each unit or anywhere else desired. Also while not shown, this embodiment can have a permanent or removable cover (not shown). It will be appreciated that all covers mentioned in this disclosure can be permanent or removable. FIGS. 44A and 44B show an alternative embodiment of a digital photo album 4400 comprised of two digital viewing units 4410, 4412 connected to a separate hinge 4415.

FIG. 45 shows an alternative embodiment of a digital photo album 4500 having a cover 4540 with sleeves or pockets 4542 and a support 4550 for a storage area 4520 and viewing unit 4510 that is insertable into the sleeves 4542. Of course, while the viewing unit 4510 is shown on the right and the storage area 4520 is shown on the left, it will be appreciated that there can be multiple viewing units, and/or with storage areas positioned in any location on the front or back of the album. The sleeves or pockets 4542 on the cover are placed or slide over the ends the digital photo album support 4550. FIG. 45 shows an old style book cover that is made of any type of material and it can have one layer or multiple layers of material. A zipper or any type of storage compartment is contemplated.

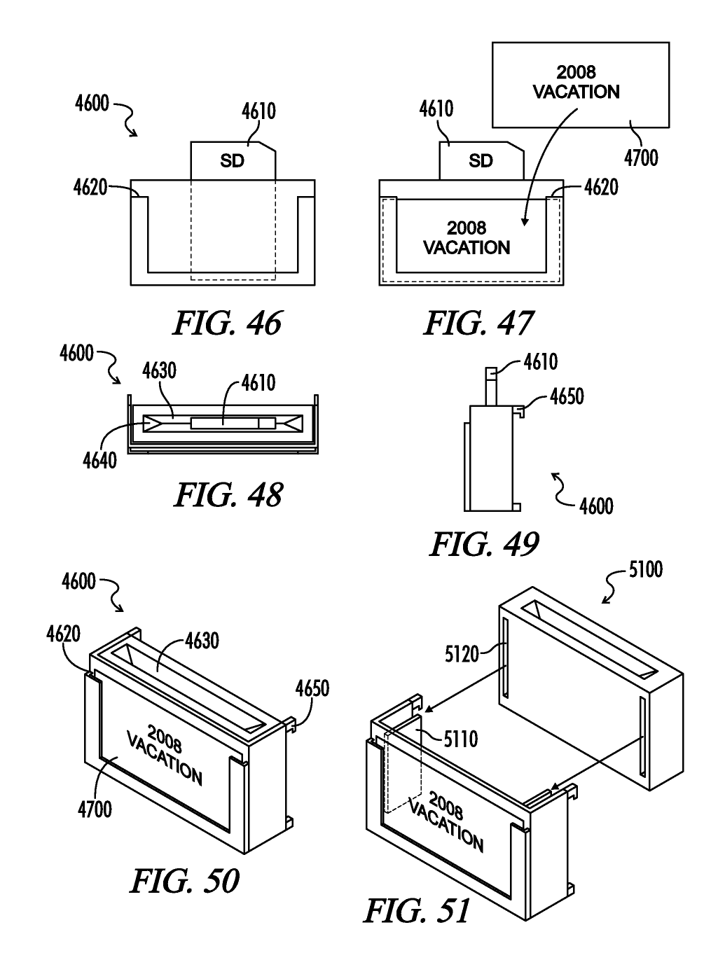

FIGS. 46-51 illustrate one embodiment of a universal storage pocket or compartment 4600 for holding digital media as described herein for use with the various digital photo album embodiments described herein. FIG. 46 shows a front view of the compartment or pocket 4600 with a SD memory card 4610 inside that is shown for purposes of illustration. The universal pocket or compartment can fit any size memory card, memory stick, flash drive or any similar device known now or developed in the future. Depending on the size, one to multiple devices can fit inside the pocket or compartment 4600. FIG. 47 illustrates a label or name tab 4700 that can be placed or slid into slots 4620 on the front of the pocket or compartment 4600. The name label or tab 4700 can also be glued or otherwise removably or permanently affixed using a variety of means. The name tabs or labels 4700 are a great way for the user to identify what's inside the memory card or like device 4610. FIG. 48 illustrates a top view of the pocket or compartment 4600 containing a memory device 4610. The area 4630 inside and around the memory card or device 4610 can be tapered 4640 for easy entry. The material can be soft material like rubber or foam, harder-type material or any type that helps protect and hold the memory card or device in place. With a flexible, resilient material inside area 4630, it makes it possible to hold thick and thin memory cards or similar devices in place, which allows the storage area to be more universal, so the user can place any type of memory card or any similar device in the universal storage compartment or pocket.

FIG. 49 illustrates a side view and FIG. 50 illustrates a perspective view of a universal pocket/compartment 4600 with memory card or similar device sticking out of the top 4610 and with connectors 4650 for attachment to a digital photo album storage area as will be described below.

FIG. 51 illustrates one embodiment of a compartment 5100 having legs or extenders 5110 that extend into the device area 5120, which may be comprised of rubber, foam or other resilient material to hold it in place or it can have adhesive to secure it. The assembly, design or attachment of the universal storage compartment pocket can be any type known now or developed in the future. The material can be any type of material known now or in the future. There can be label areas where the user can add and remove labels so the user can identify what memory card or device is in the storage area. The label area can have grooves or slots where it holds a paper or any material label in place. The label can be an adhesive label or not.

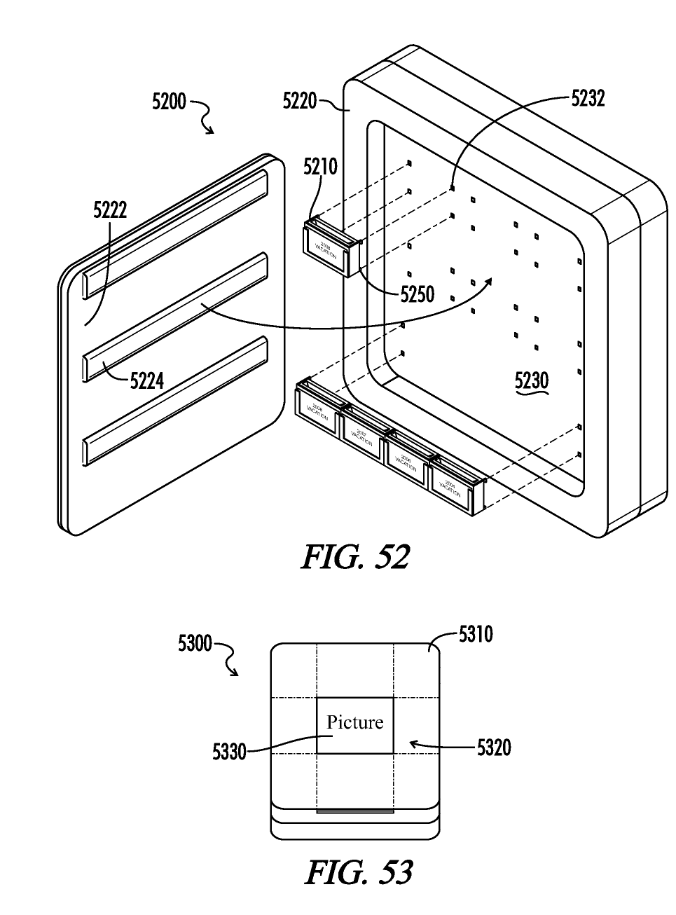

FIG. 52 illustrates a partial view of one embodiment of a digital photo album 5200 including a storage area 5220 with an individual storage compartment/pocket 5210 being attached to a storage support structure 5230. The bottom section shows a row of connected universal storage compartments or pockets 5210 that are then connected to the support structure 5230 of the storage area 5220 through the engagement of connectors 5250 with openings 5232 in the support structure 5230. The storage area 5220 can have any amount, any combination of compartments or pockets. In the illustrated embodiment, a storage door or cover 5222 is provided, which can be attached using a variety of means. The inside of the storage door 5222 can further comprise areas of padding 5224 that stick out farther than other areas of the inside of the storage door 5222 so they can hold the memory card or devices in place and so they don't move around. The padding 5224 also aids in protecting the memory card or devices. In the storage area 5220 or door, there can be also other material that is heat barrier to protect the memory card and like devices. The storage area can be fire proof and water proof.

FIG. 53 illustrates one embodiment of a digital photo album 5300 having a front cover 5310 with a picture area 5320 and a variety of potential placement locations for insertion of a picture 5330 into the picture area 5320.

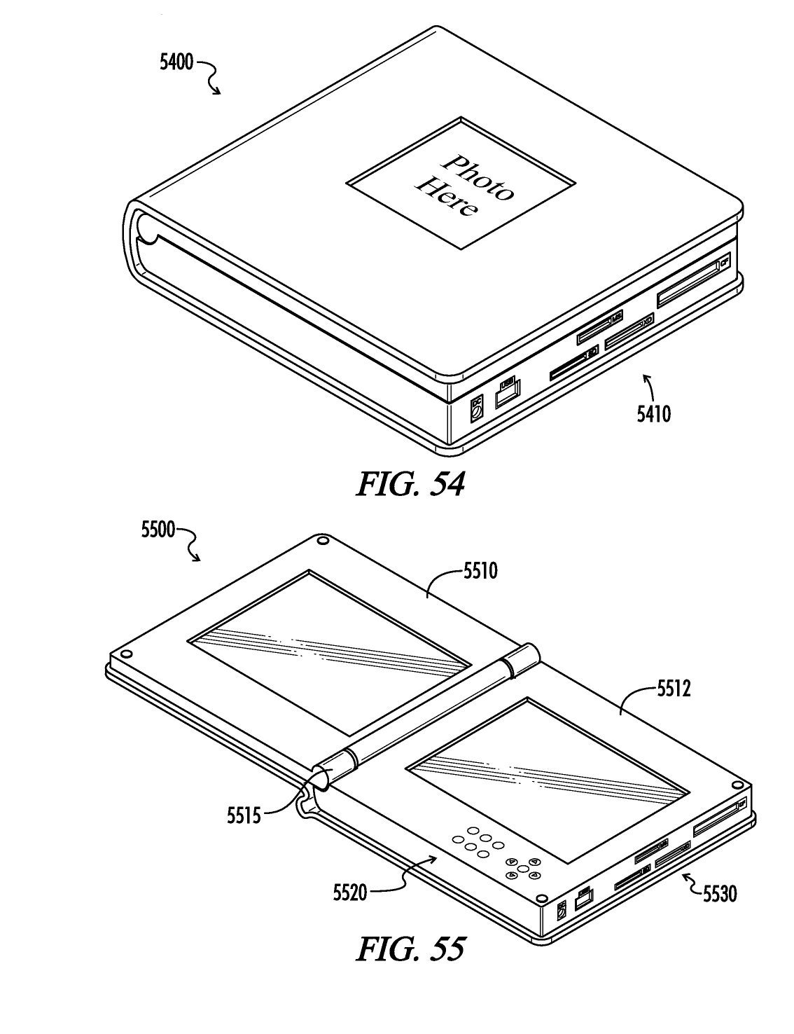

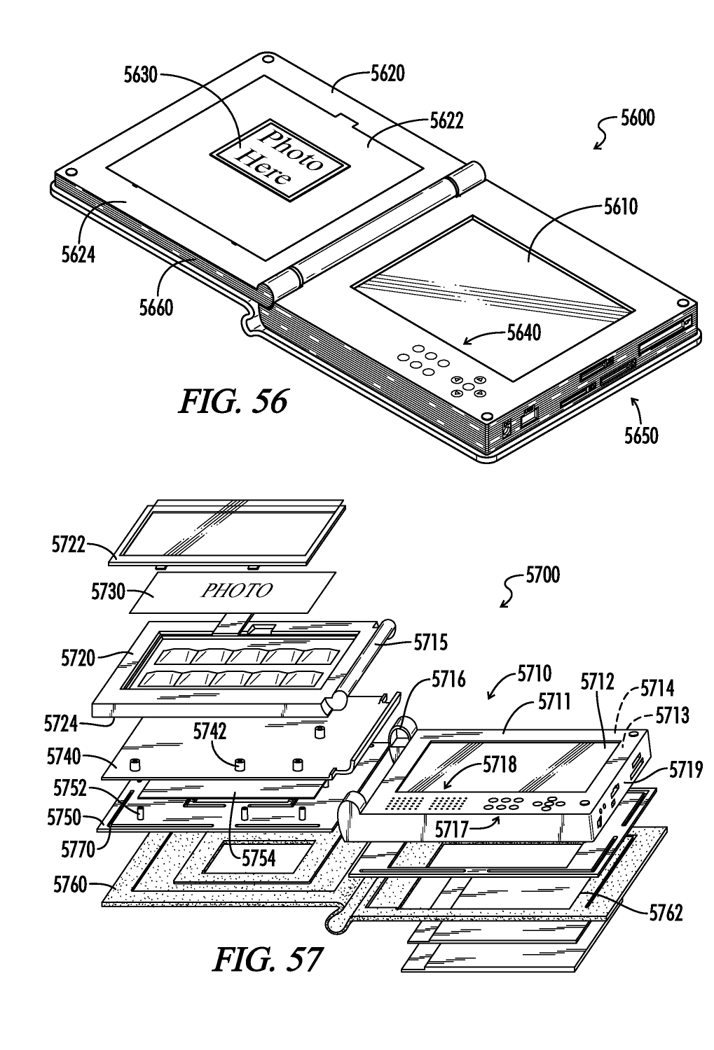

FIG. 54 illustrates one embodiment of a digital photo album 5400 in the closed orientation that looks like a typical photo album or book. The digital photo album can be designed in many different ways, however this application may show many versions, but many more are possible. Also shown are examples of port openings 5410 with the name or abbreviation of the port, next to the opening. There can be grooved lines (FIG. 56) or any type on the side of the album to make it look like actual paper pages. FIG. 55 illustrates one embodiment of a digital photo album 5500 having two display screens 5510, 5512, a control panel 5520 and port openings 5530. The rounded hinge 5515 shown is constructed partially from each display screen, which provides a clean, attractive appearance. Control buttons can be used or touch screen technology or touch border interface. In other words, with a touch key interface there will be icons like arrows and menu icons to operate, but with no tactile buttons. A thick plastic screen protector, for example, can be placed over the screen 5512 to be flush with the unit, and has smooth surface icons, like arrows and a menu icon printed on it, so the consumer can easily operate the unit in a touch fashion. In one embodiment, the screen protector might be a piece of plastic 2 mm thick, the icons are printed on the inside panel first, and then a white painted border is painted around the border and a screen area is left clear in the middle, so when the cover is placed over the display screen, the display screen will show through the cover.

FIG. 56 illustrates one embodiment of a digital photo album 5600 having a display unit 5610, a storage area 5620 with a picture area 5630 on the door 5622 of the storage area 5620, a control panel 5640, ports 5650 and the appearance of lines 5660 along the sides to simulate pages of a book. The storage door 5622 has a place 5630 to insert a picture or art card or any document. Thus, instead of presenting a plain storage door, it can also offer the user more by allowing them to place a picture of a friend, loved one, animal, art card or any kind of document. The surrounding area 5624 around the door 5622 can have plastic or other material raised or other designs to resemble a frame around the picture area 5630.

FIG. 57 illustrates an exploded view of another embodiment of a digital photo album 5700. The number of layers shown is illustrative for purposes of example only, as variations in this embodiment can have more layers or fewer layers as desired. Each layer can have a purpose and is not limited to the number of layered parts shown. While FIG. 57 illustrates a single display screen 5710, the invention is not limited as such and can have multiple display screens as desired and as illustrated in various embodiments disclosed herein. Furthermore, while a single storage area 5720 is shown, variations in location and placement are possible. In addition, left and right side placement in the digital album 5700 is variable, such that the parts can be located on any place and any side. On the top left side one part shows a storage door 5722 and picture 5730 for sliding into or placed in the storage door 5722. Another part below shows a storage area 5720 and the right side has a hinge assembly 5715. Another part is under the storage area 5720 and is a back plate 5740 with connectors 5742 that attaches to the back 5724 of the storage area 5720. Below the back plate 5740 is part of the cover 5750, that is stiff or flexible or any type of material that the outside cover 5760 is attached to. This part 5750 also has connectors 5752 to connect to the back plate 5740 and if there was no back plate, then it would attach to the back 5724 of the storage area 5720. This part can also have an area used for sliding or placing a picture or art card 5754 between the cover and the body of that particular side of the album 5700. The openings 5770 around the perimeter are used to sew the leather or any type of outside cover 5760 that is shown below to a firmer part of the cover, and then this part is attached to the back plate 5740 or the storage area 5720. The cover 5760 can also be glued or attached in any way known now or developed in the future to the digital photo album. The right side of FIG. 57 shows the digital viewing unit 5710 with a hinge assembly 5716 on the left side. This part can have several parts to make this but not limited to a face plate 5711, screen 5712, CPU 5713, battery 5714, buttons 5717, speaker 5718, port parts 5719 and openings, electrical components and all hardware to make the unit function. The back, side or anywhere of this unit can have a battery compartment or storage compartment and there can be a door or cover for each or together. The cover 5760 is shown to be one piece; however there can be one or several pieces. The cover can have an opening 5762 for the picture, LCD screen or art card showing through the front. It can also have openings for compartments like battery, or storage areas and the cover or door can have leather or any type of material on it as shown on the bottom right side.

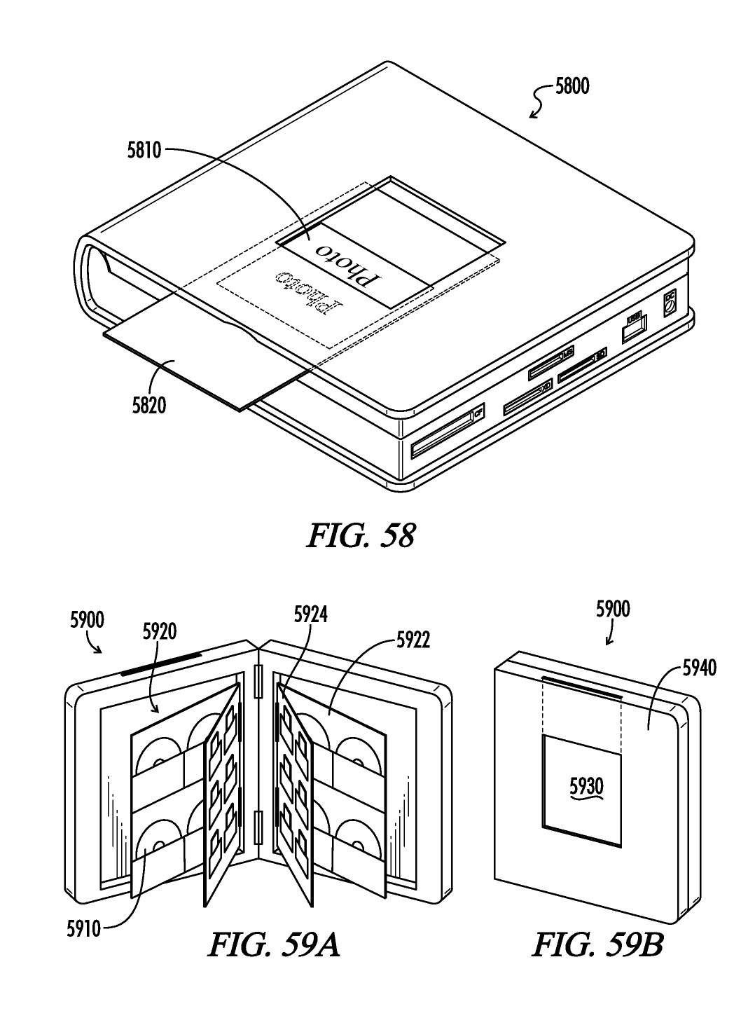

FIG. 58 illustrates another embodiment of a digital photo album 5800 in the closed orientation and showing how a picture 5810, art card or other can be inserted in and out between the cover and the body of the album. The picture, art card or other can have a plastic sleeve 5820 protecting the picture, art card or other. The plastic or type material sleeve can stick out past the body, but not past the cover and the user can grab the sleeve and be able to pull the sleeve and picture, art card or other in and out of the digital photo album. Inside the storage area can have an area where the user can insert a picture, art card or other in and out and it will show through the front of the album

FIG. 59A illustrates another embodiment of a digital photo album 5900 in the open orientation showing a digital photo organizer that holds and stores digital photo storage devices 5910 like CD's, memory cards, memory sticks, flash drives or any other devices known now or developed in the future. It looks like a photo album book. There can be pages 5920 like shown, that the user can add or take out pages as needed. Some pages 5922 may be custom fit for CD's, while some pages 5924 may be custom fit for memory cards and similar devices. The pockets and pouches would be custom fit to fit all types of digital photo capturing cards or devices known now or developed in the future. FIG. 59B illustrates a closed orientation of the digital album 5900 that shows where a picture or art card 5930 can be placed, so it will show through the front cover 5940. The insert area can be from the top, anywhere or from the inside of the storage area.

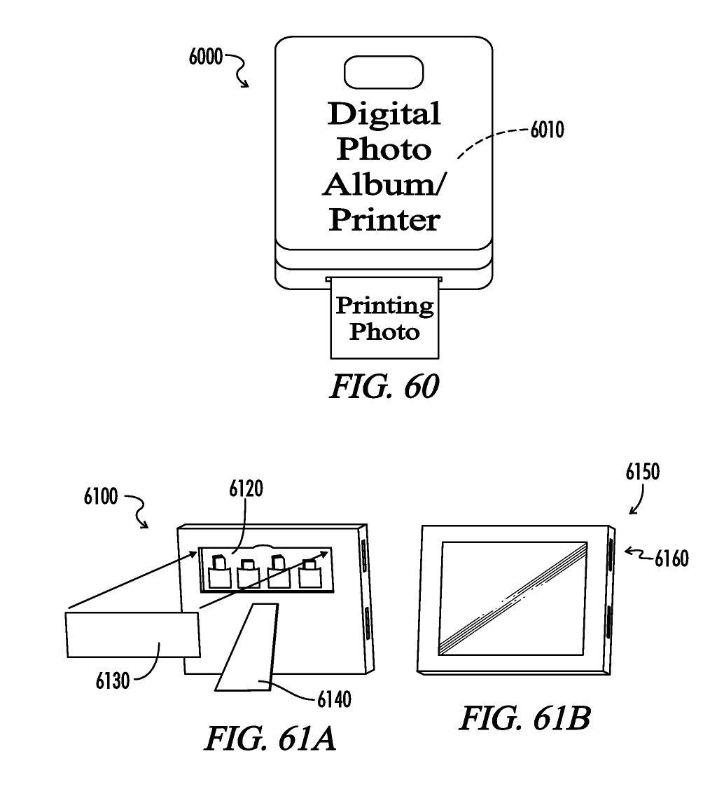

FIG. 60 illustrates another embodiment of a digital photo album 6000 that includes a built-in printer 6010. The printer can be any type size or shape and be locate anywhere within the digital photo album. The digital photo album can also have printer ports to connect to an external printer.

FIG. 61A illustrates a rear view of another embodiment of a digital photo album 6100 showing a storage area/compartment 6120 and cover 6130 on the back. Also shown is a support 6140 to enable the album 6100 to be propped on a desk or other support surface. FIG. 61B shows an album embodiment 6150 with a storage/compartment 6160 on the right side. The storage area/compartment in the digital photo albums as described herein can be anywhere, any size, type, in or on the frame or any way mentioned in this application or known now or developed in the future.

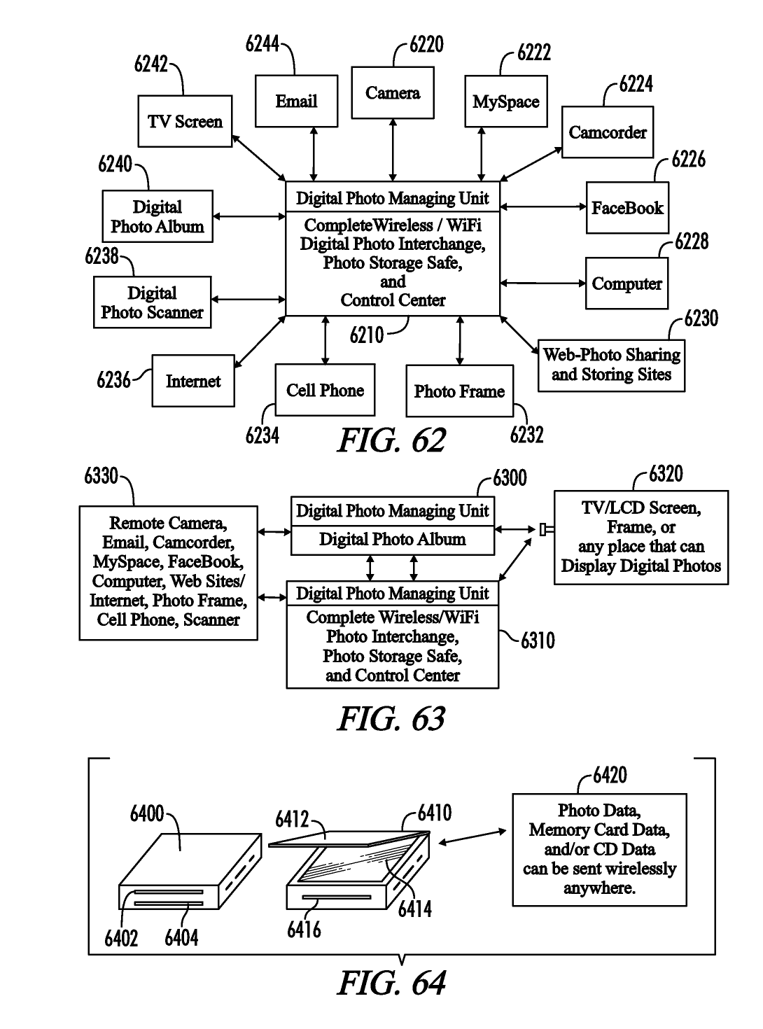

FIG. 62 shows a wireless digital photo managing and storing unit 6200, which can be contained inside any type of digital photo album discussed herein or developed in the future. It also illustrates a flow chart for sending, managing, receiving and storing digital photos in a Complete Wireless/WiFi, Digital Photo Interchange, Photo Storage Safe, and Control Center 6210. One preferred way to send, receive and store digital photos is wirelessly. In FIG. 62, the managing and storing unit 6200 can be the main storing medium for digital photos, where the user can safely store digital photos without worrying about losing any of their valuable photos. This unit can be shaped any way possible; can have a hard drive, built-in memory and also have an external hard drive to store all the photos. This unit can be plugged in; it can have batteries, battery backup or any possible energy to operate. In one embodiment, an internal memory can consist of all memory cards or memory expansion cards, where there is no hard drive or moving parts. This will ensure no loss of photos. The unit can have a LCD-type screen to view any sending, receiving and storing information. In FIG. 62, there are illustrated double arrows coming to and from the Digital Photo Managing and Storing Unit 6200 and the Control Center 6210. Photos and videos are displayed, viewed, shared, and used in cameras 6220, MySpace® 6222, camcorders 6224, Facebook® 6226, computers 6228, web-photo sharing and storing sites 6230, photo frames 6232, cell phones 6234, via the Internet 6236, digital photo scanner 6238, digital photo albums 6240, TV screens 6242, emails 6244 and other places known where digital photos can be located. This flow chart shows how digital photos and videos can be sent wirelessly to and from the digital photo managing unit 6200 and digital photo storage safe and control center 6210 or within the digital photo album. The unit 6200 can have a wireless router, WiFi (not shown) and built-in software to manage digital photos, send, store, locate, and/or receive digital photos. The unit 6200 can have a server (not shown), and/or a personal web site (not shown) where a user can communicate with the unit 6200 to find photos send and receive photos and videos anywhere. The photos can be located in separate memory card areas. The unit 6200 can hold thirty memory cards, for example, of any size and the user can communicate and send or receive photos and videos from any storage compartment. The photos and videos can be organized and labeled for quick access by the consumer. For example; a camera 6220 if it had wireless capabilities, can send photos to the unit for safe storage. For example, the user can take a picture with a cell phone 6234 and send photos to the digital photo managing unit 6200 and place the photos or videos in a safe location. The user can access the stored photos at any time and send, receive, share and store photos without the worry of losing photos. By sending digital photos and videos wirelessly, it makes it convenient for everyone especially when all your photos and videos can be located easily in one safe location.

FIG. 63 illustrates a digital photo album 6300 which can contain a digital photo managing unit 6310 or can be separate. It also shows a flow chart for sending, receiving, managing and storing digital photos to TV screens 6320, or any type of screen, frame or any place that can display digital photos known now or developed in the future. FIG. 63 illustrates the concept that a consumer can send and receive photos and videos wirelessly to the TV, or any place that digital photos are displayed from a digital photo album, digital photo managing unit, remote camera, email, etc. 6330, or any type known now or developed in the future.

FIG. 64 illustrates two embodiments of a wireless digital photo scanner 6400, 6410 that can send digital photos wirelessly to any location. Either scanner can be any shape or size. With one embodiment of a scanner 6400, a user slides a photo of any size into the front slot 6402 and the unit scans the photo to a memory card, CD, etc., 6420 and the user can send the photo or wirelessly to any location. The scanner 6400 can have CD port 6404, for example, for copying photos or videos to memory and can send the photos or videos wirelessly anywhere. Another scanner embodiment 6410 has a flip top 6412, where a user can place a photo on top of the screen 6414 and scan the photo to a memory card, CD, etc., 6420, and the user can send the photo or wirelessly to any location. The scanner 6410 can also have CD port 6416, for copying photos or videos to memory and for sending the photos or videos wirelessly anywhere.

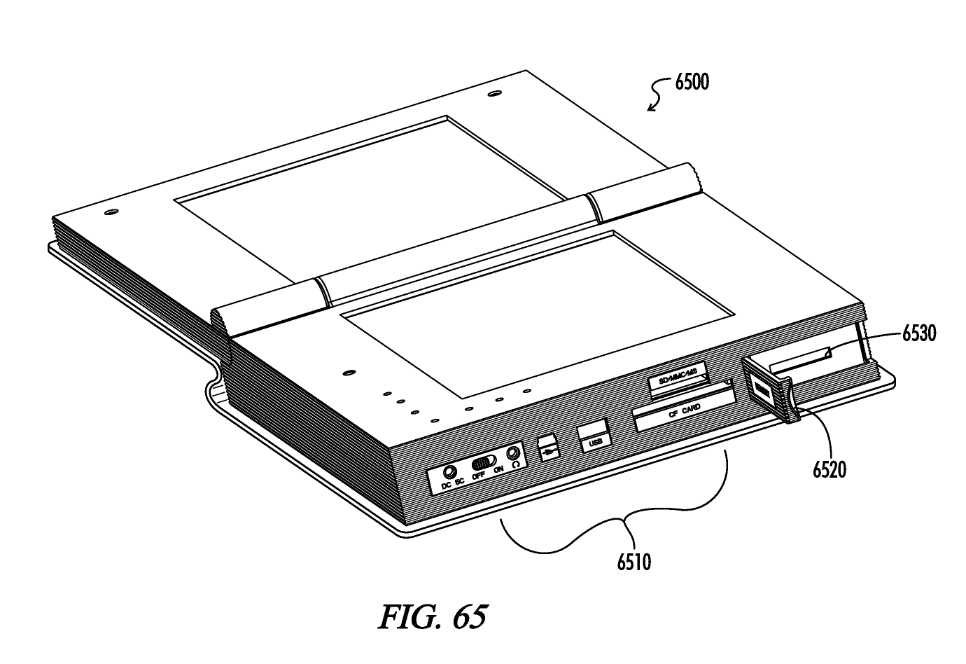

FIG. 65 illustrates one embodiment of a digital photo album 6500 having port openings 6510 and an external memory compartment door 6520 open with access to a removable memory 6530 like a memory card for example. The port openings 6510 can be any size, shape and can have any type connection to any cable, any electronic device, camera, cell phone, computer, any photo capturing device, video, music ports, memory card ports, etc., a power switch, AV out, speaker port or any port/slot known now or developed in the future. Other ports are contemplated. FIG. 65 also shows a memory compartment for access to the album's built-in memory. Most digital photo frames of today come with built-in memory, so the consumer can store photos inside the unit and view them at any time. The problem with this is if the digital photo frame goes bad, then the consumer cannot retrieve those photos. To solve this problem, the embodiment of the digital photo album 6500 would have built-in memory for photos, videos and music, but the built-in memory would be stored in a memory card or a like device and can be removable. If the digital photo album 6500 has a defect and does not work, the consumer would never lose their photos because they can access the external storage compartment and pull out their removable memory card for example. Another important benefit relating to the embodiment of FIG. 65 is easy access to the removable memory, which allows consumers to increase the memory of the digital photo album 6500 at any time with no effort. If a consumer had a one gigabyte memory card in the unit, the consumer can increase the memory of the unit by replacing the existing memory card with a higher capacity memory card.

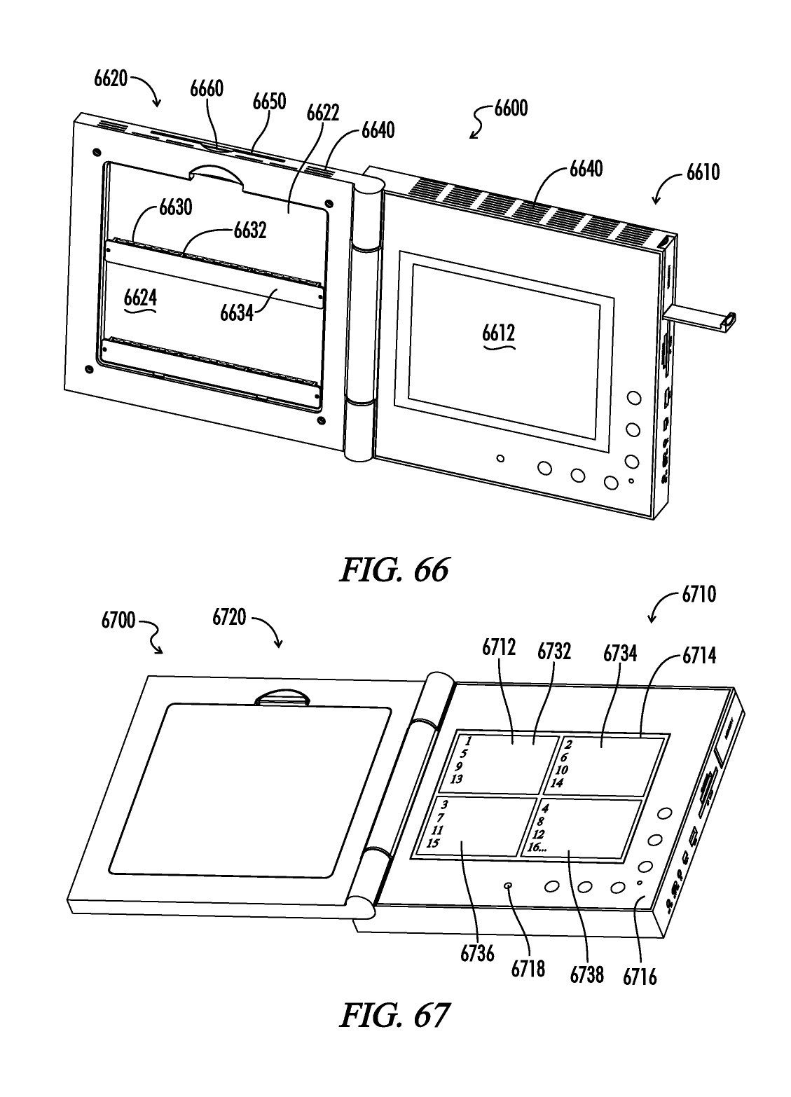

FIG. 66 shows one embodiment of a digital photo album 6600 with a digital viewing unit 6610 on one side and a storage area 6620 on the other side memory card and similar devices can be stored. In one embodiment, the back wall 6622 of the memory card storage area 6620 can have rubber, plastic, or foam type material 6624 that is attached by glue, snap, screwed or any way known. Then, an individual, or multiple compartments 6630 with dividing walls 6632 can be snapped, screwed or any way known to the back wall 6622 and enclose the rubber, foam type material 6624. While there can be any number of rows or individual compartments 6630, the embodiment of FIG. 66 illustrates for purposes of example two rows of individual compartments with three sections in each compartment. For example, two SD or XD cards and one compact flash card can fit into each individual compartment. The compartments can fit any number of memory card and similar devices and can be any shape or size. In front of the compartment area 6630, there can be, for example, PVC plastic heat sealed and glued to the front of the compartment to create a sleeve or pocket 6634 for inserting name tabs to identify what's inside the memory card or similar device. This way it allows the consumer for easy identification of the photos, videos stored in the storage compartment. The inside of the storage area 6620 can have padding, rubber, or foam type material to hold the memory card and similar devices in place, so they will not move around when the digital photo album 6600 is carried or is upside down for example. Vent holes 6640 are provided on the top of the storage area 6620 and above the display panel 6612 of the viewing unit 6610 to allow heat to escape. In addition, speakers can be located behind this area. The vent holes 6640 located above the storage area 6620 are generally for cosmetic purposes to match the vent holes 6640 located above the display panel 6612, such that when the album 6600 is closed the two sides 6610, 6620 would be together and the vent holes 6640 would match. FIG. 66 further illustrates a slot 6650 above the storage area 6620 where the plastic cover and picture or art card (printed “Memories” for example), slides in and out and appears in the front of the album 6600. A groove 6660 is located in the middle of the slot 6650 to allow the user to insert their finger in this area to get a hold of the plastic cover with picture in and out. This can be located anywhere or be any size and shape.

FIG. 67 illustrates one embodiment of a digital photo album 6700 in the open position with a digital viewing unit 6710 to the right and a storage area 6720 to the left. The storage area 6720 can be blank or have a place to insert a printed photo or the like. In such embodiment, a touch key function with touch key sensor technology is shown. The digital display 6712 has an outer surface that is flat with no raised surface and it also can comprise a touch border interface, where the user touches a border 6714 around a displayed photo to operate the device. Silk screen or printing can be placed on the touch key areas, so the user can know where to touch and operate the unit quickly and easily. In one embodiment, the touch key areas can be placed in the lower right corner 6716, so when the user is holding the unit, they can comfortably and easily locate and touch the touch key areas easily without effort of moving their entire hand around; they would only move their fingers, or thumb for example. A remote sensor 6718 can be located anywhere on the unit, but FIG. 67 shows it in the middle below the display 6712.

FIG. 67 illustrates one embodiment of a digital display 6712 that is selectable from a full-screen mode or a four-photo mode. In a full-screen mode, a user can choose to watch full screen photos, videos, and if they want to view full screen photos, photo #1 would appear and when they click next, photo #2 would appear and if they click next again, photo #3 would appear and if they choose previous, then it would take them back to the previous photo and so forth. In four-photo mode with display areas 6732, 6734, 6736 and 6738 as shown specifically in FIG. 67, the numbers in the photo areas indicate picture order and can go on for as many photos that are in the memory or the number of photos in the card port or USB ports, etc. The photos can appear in any order or any time, or any number of photos or size. If the user decides to view four photos, then four photos could appear at the same time, but for example shown in FIG. 67, photo #1 could appear in display area 6732, then photo #2 could appear in display area 6734, then photo #3 could appear in display area 6736, then photo #4 could appear in display area 6738. When a user clicks the next key or button, photo #5 could appear in display area 6732, then photo #6 could appear in display area 6734, then photo #7 could appear in display area 6736 and photo #8 could appear in the display area 6738. If the user clicks previous, then it would take the user back to the previous four photos and so forth. The photos can be delayed when appearing or be at the same time. The user can select slide show or transitional effects at any time. By using four photos appearing or any number, it gives the effect of viewing photos like a typical photo album but without physically flipping pages.

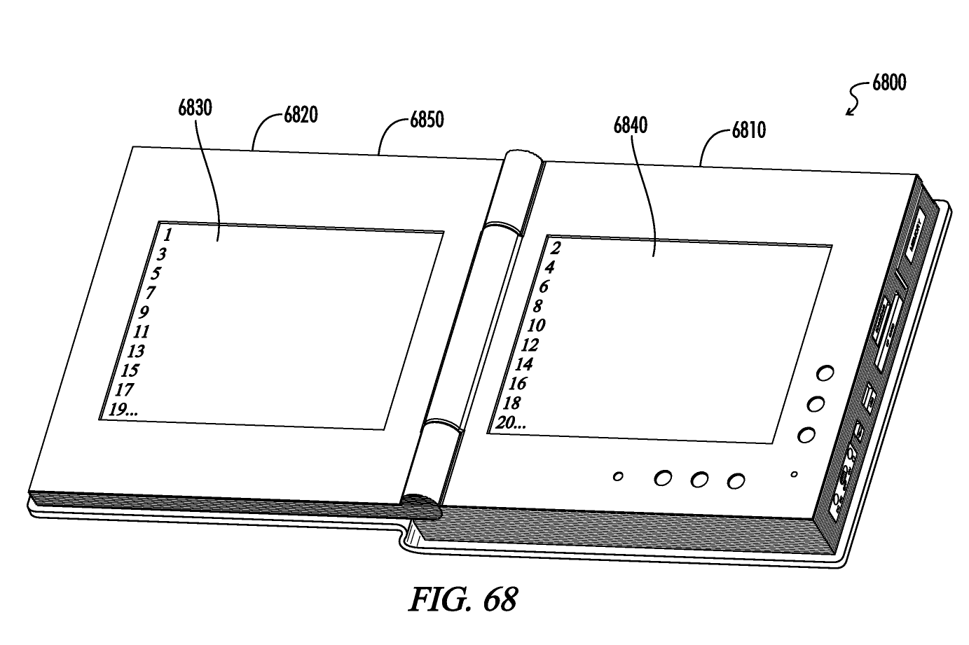

FIG. 68 illustrates one embodiment of a digital photo album 6800 open with two full-screen digital display units 6810, 6820, having display areas 6830, 6840, with a storage area 6850 on the back of one of the display units 6810, 6820 or not being present in such embodiment 6800. A user can choose to watch full screen photos, videos, etc., and if they want to view full screen photos, photo #1 would appear in display area 6830 and photo #2 would appear in display area 6840, and if the user clicks next again photo #3 would appear in display area 6830 and photo #4 would appear in display area 6840 and so forth. If the user chooses previous, then it would take them back to the previous photos and so forth. The photos can be delayed when appearing or appear at the same time. The user can select slide show or transitional effects at any time.

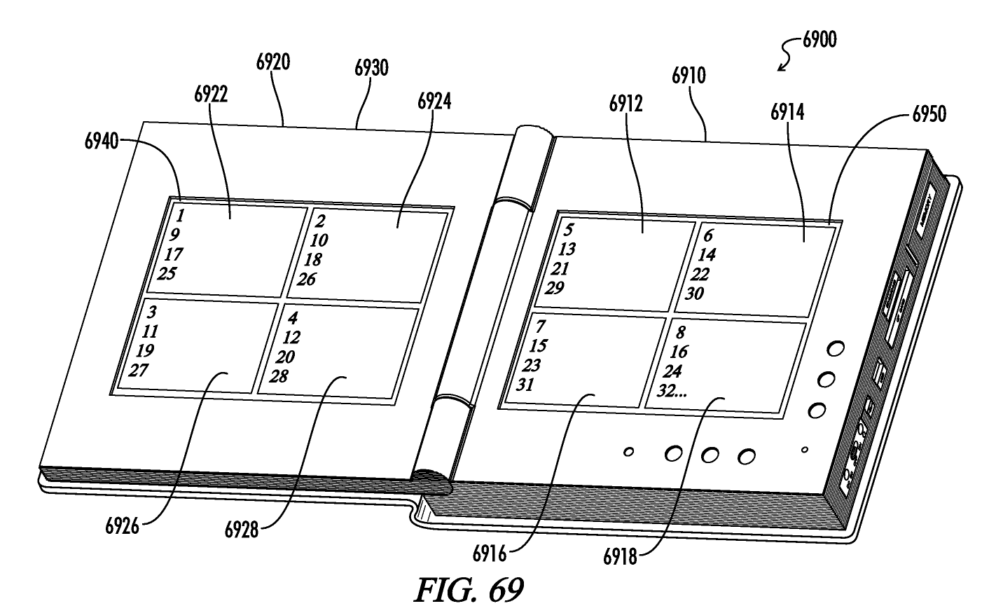

FIG. 69 illustrates one embodiment of a digital photo album 6900 open with two full-screen digital display units 6910, 6920, having display areas 6912, 6914, 6916 and 6918 on display unit 6910, and display areas 6922, 6924, 6926 and 6928 on display unit 6920, with a storage area 6930 on the back of one of the display units 6910, 6920 or not being present in such embodiment 6900. As shown in connection with other embodiments described herein, the numbers in the display areas can indicate photo order and can go on for as many photos that are in the memory or the number of photos in the card port or USB ports, etc. The photos can appear in any order or any time, or any number of photos or size.

In a dual-display, four-picture mode as shown in FIG. 69, one embodiment of a navigation solution would designate display area 6922 as a navigation display, all other display areas 6924-6928 and 6912-6918 being dependent on the first display area 6922. So, for example, if a user advances to photos #25 through #32 in display areas 6922-6918, but the user desires to see photo #9 again, the user can select “previous” until photo #9 is in display area 6922, with the remaining display areas showing photo #26 through photo #32. If the user then selects “next,” then photo #10 will replace photo #26 in display area 6924, and then hitting “next” will result in photo #11 replacing photo #27 in display area 6926, and so on. In other words, in this example, hitting “previous,” will trigger only a navigation of the photo in the display area 6922, all other display areas remaining unchanged. Of course, other navigation options employing all illustrated display areas are contemplated, such as a user being able to flip through four or eight pictures at a time, or one at a time, or two at a time, as the case may be. If the user clicks previous, then it would take the user back to the previous four photos per screen which is eight photos and so forth. The photos can be delayed when appearing or be at the same time. The user can select slide show or transitional effects at any time. In addition, in one embodiment there can be a border 6940, 6950 around each photo or collection of photos or display area or areas, which border can be any color, shape, size, etc., and can look like frames. In the menu, a user could have the option to choose frame styles, border styles or colors of any kind, etc.

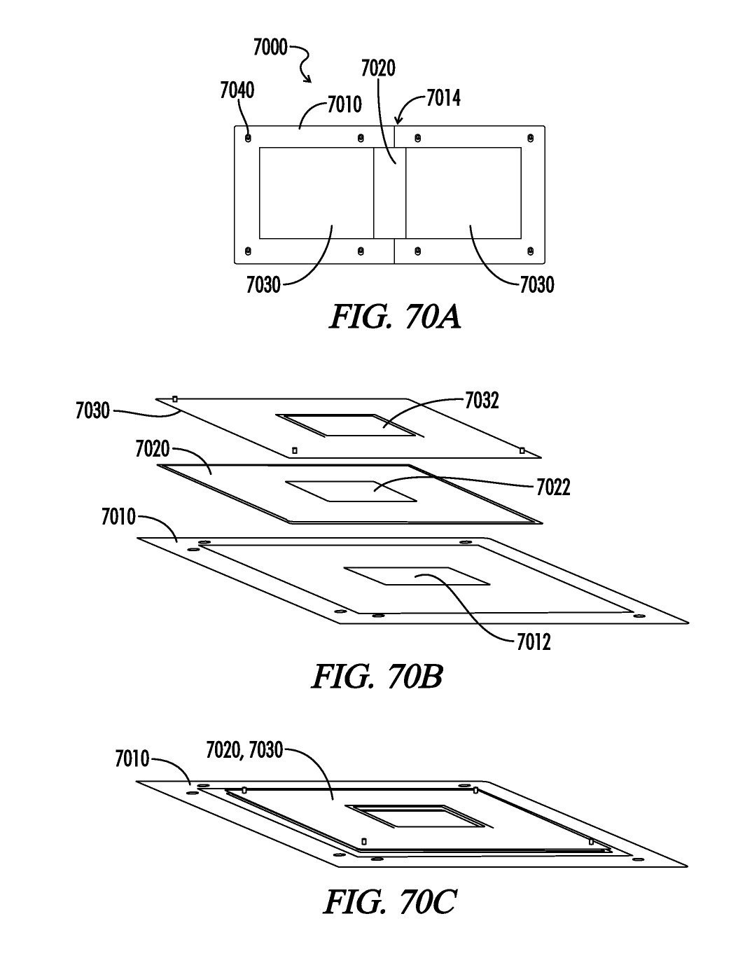

FIGS. 70A-70C illustrate one embodiment of a method of creating a digital photo album cover 7000 to encase or cover a digital photo album as described herein, and generally further comprises a support cover 7010, a binding material 7020, and an encasing cover 7030, each of which can have a window 7012, 7022, 7032 for displaying a picture (not shown) therethrough. The support cover 7010 can be leather, leatherette, or any other material. The binding material 7020 is preferably a cardboard or other paper stock, although other materials are contemplated. The encasing cover 7030 is preferably a harder plastic material to add some rigidity to the cover 7000 and to provide a support for attachment to a digital photo album, although a variety of materials are contemplated. FIG. 70A illustrates two support covers 7010 connected by the binding material 7020 with encasing covers 7030 attached through the binding material 7020 and to the support covers 7010 as shown in FIG. 70B. FIG. 70C illustrates the attachment of all layers 7010, 7020, 7030 of one side of an album cover 7000.

FIGS. 70A-70C illustrate one way of attaching a leather cover to a digital photo album, but is not limited to this and can be done any way know now or developed in the future. FIGS. 70A-70C show a leather cover with openings 7012, 7022, 7032 for a picture or pictures for the front of the digital photo album, and can also have a hole (not shown) for a rear storage area for a dual screen digital photo album as described herein. A picture for the front the album can optionally be included. A variety of holes 7040 are positioned in strategic locations around the cover 7000 for attachment of the cover 7000 to a digital photo album housing. Binding material 7020 is a cardboard, paper, book cover type of material to create a book cover appearance, so it will make the digital photo album feel comfortable when holding and appear like a conventional book-type photo album. The binding area 7014 is preferably formed from thinner cardboard, paper type material, and is glued or otherwise attached to the support cover 7010, with stitching being made around the perimeter, any style or shape to give a nice appearance, There can also be stitching around the picture area that appear in the front of the album. The binding material in the binding area 7014 is preferably sewn a specific distance away from the inner edge of the cover 7010 and digital photo album housing. In this area between the binding and the inner edge of the cover and housing, the inner part of the housing with leather and hinge (top part) goes inside the other part of bottom housing and hinge assembly, when its completely open. If you reverse the hinges, the other side would go inside the other part, so the bottom would go inside the top, which is a useful feature to make this leather look nice and open and close nicely.

FIG. 70A also shows two plastic covers 7030 that are glued to the support cover 7010, with binding material 7020 being glued and stitched to the support cover 7010. This can be attached any way known now or developed in the future. The holes 7040 in the support cover 7010 (any number) are placed over plastic round areas, where a screw can be screwed into the opening 7040 and the cover 7010 is glued to the perimeter of the cover 7030. The cover 7030 can be raised like shown or not. Now a digital photo album housing can be screwed or any type of fastening method known now or developed in the future, to the covers 7030, which can be one or two pieces as shown. The covers 7030 are separated so that the binding area 7014 will be loose and flexible when fastening it to a digital photo album housing and so that a user can open and close the album easily. In one embodiment, a digital photo album housing would be tightened through the covers 7010, 7020 and 7030 for a strong connection.

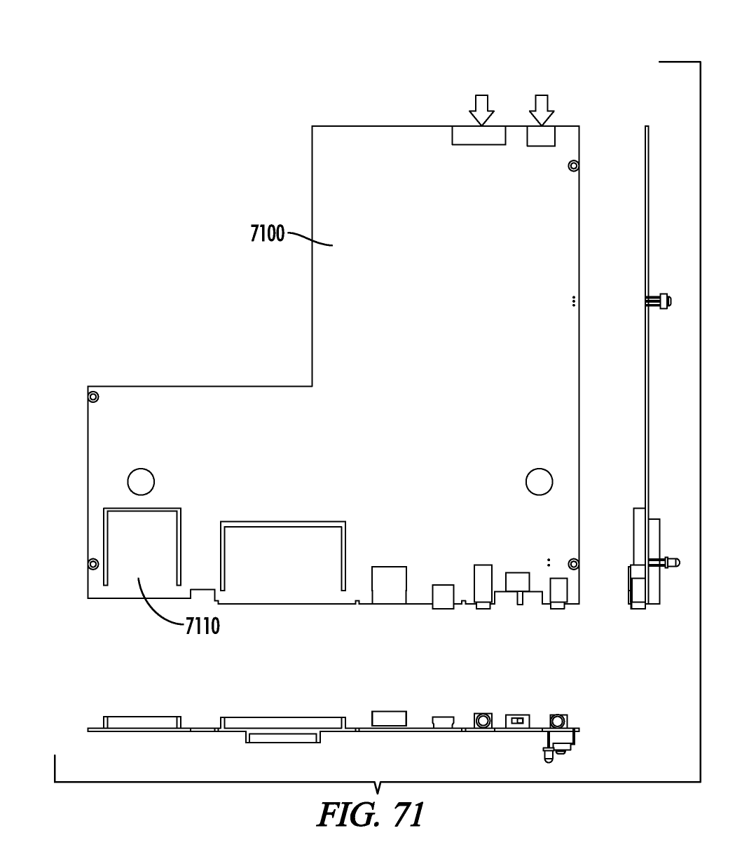

FIG. 71 illustrates a Program Computer Board (PSB) and chip 7100 having a removable memory slot 7110 that is built in the PCB and allows the user to remove and replace memory at any time from an external memory compartment as described herein elsewhere. The user would open a memory compartment and insert or replace a memory card in the slot 7110. This will allow the user to have safe photos without the chance of losing their photos from the digital photo album if it goes bad or is defective. The user can also increase or decrease the memory at any time. It is preferable that the PCB 7100 and memory card or similar device slot that can be removable from the outside of the digital photo album. The PCB 7100 can be any size shape, type, any computer chip or software that's known now or developed in the future, and can be used for any electronic device, any photo frame, etc., known now or developed in the future. For a dual-screen unit, it is preferable that the PCB 7100 communicates with a transistor in the other screen for dual-screen functionality.

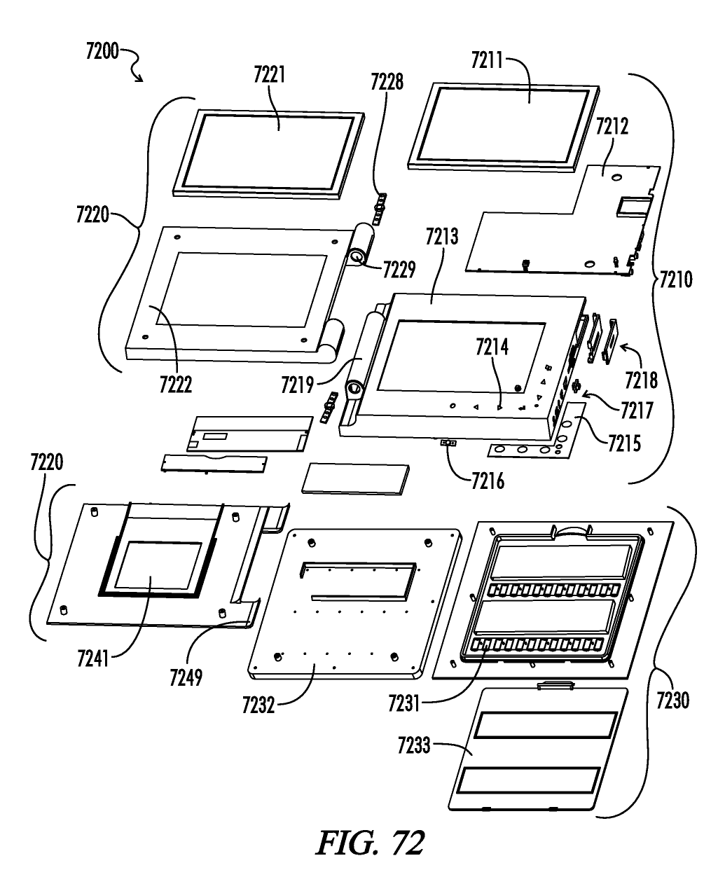

FIG. 72 illustrates one embodiment of a parts view of a dual-screen digital photo album 7200 with two digital viewing units 7210, 7220 generally and a storage area 7230 generally on the back of one of the viewing units 7210, 7220, and with a leather (or the like) cover removed for ease of illustration. The details of each of these units 7210-7230 are described above, and it is understood that the size, shape, etc., can be varied as desired by the user. Unit 7210 generally comprises a screen 7211 and PCB 7212 contained within a cover 7213, the cover 7213 having navigation buttons 7214 under a touch pad 7215, a remote port 7216, various input/output ports 7217 and a removable memory area 7218. A hinge area 7219 on the unit 7210 engages with hinge 7229 on unit 7220 via hinge fasteners 7228. In this embodiment, the plastic housing or cover 7240 that attaches to a leather cover, for example, as described in FIGS. 70A-70C, can have part of the hinge assembly 7249 molded or attached to it for engagement with the hinge assemblies 7219 and 7229 of units 7210, 7220. Unit 7220 further comprises a display 7221 contained within a cover 7222 that engages with cover 7240, which cover 7240 has a window 7241 for displaying an inserted photo or the like. Storage area 7230 further comprises storage locations 7231 situated on a backing 7232 for holding memory cards or the like, and a cover 7233 for access to the storage locations 7231. A battery or other power source can be built into the digital photo album or be removable therefrom, or both as desired. Any type of power source known now or developed in the future, including direct plug-in, is contemplated.

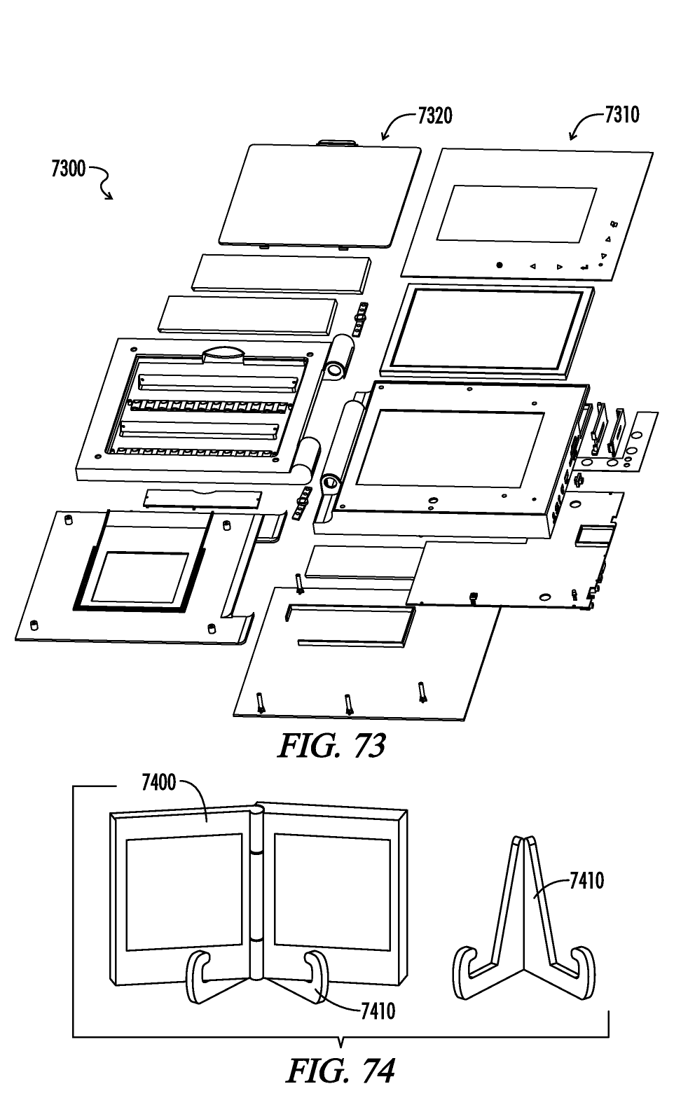

FIG. 73 illustrates one embodiment of a parts view of a digital photo album 7300 having a digital viewing unit 7310 on one side and a storage area 7320 on the other side, and with a leather (or the like) cover removed for ease of illustration. The details of each of these units 7310 and 7320 are described above, and it is understood that the size, shape, etc., can be varied as desired by the user.

FIG. 74 illustrates one embodiment of a digital photo album 7400 and holder 7410 for displaying the digital photo album 7400 in the vertical position, on a counter, coffee table or anywhere, similar to a digital photo frame. A remote control can be used in connection with a remote port provided on the digital photo album for navigating through pictures, videos, etc., while physically spaced from the album 7400. A user can open the digital album 7400 like a book and store it in the holder 7410 and view photos and video with a remote. The holder 7410 can be any size, shape, design or any type of material, and preferably has hinges for adjusting the amount of opening or it can be designed to fold flat for insertion into a digital photo album gift box, for example, and/or offered as a bonus or can be sold as an accessory.

With respect to any digital photo album described herein, the software used can be any type known now for digital photo frames or developed in the future, any type of software for viewing digital photos and videos known now or developed in the future. For example, most digital photo frames and software do not have dual screens or the ability to display photos like a typical photo album on one screen and two screens connected together like a typical photo album without pages. For example, the digital photo album of a one and a two screen model can have typical digital photo frame software, that just allows the user to view full size images and whatever else digital photo frame software is capable of.

Alternatively, a new software solution can be developed and added to any digital photo frame software that includes, any content described in this application, for viewing digital photos and videos. Most digital photo frames are designed for single-screen photo frames, but not for a digital photo album of the likes described herein where a consumer can view photos on one or two screens and view them with the option to view full size images, four photos or any number or size photos on one screen or two or multiple screens. Photos can appear at the same time or be delayed and operate like described in connection with FIGS. 67-69, for example. Or photos can appear at random, any order sequence or any way possible. A menu can appear on the right or left screen in a dual screen digital photo album, which menu can describe the display mode any way possible, but can be like, “Full Size”, and “4 Photos”, any number of photos, or have Thumbnails or any other name or way to describe the items in the menu. Additional features include the ability to rotate photos, adjust contrast and color of photos, and the screen brightness and adjust anything relating to viewing and editing photos, video, music and movies. In addition, most consumers edit, crop, delete, and change color of photos on their computer. Software can be provided to the user, so they can edit photos, arrange photos, add captions, add Multi-Transitional Effects, Zoom-In Detail and Zoom-Out Detail, or create slide shows of the album on their computer. Or the digital photo album can have this software embedded. After consumers edit, arrange photos, add captions, Multi-Transitional Effects, Zoom In Detail and Zoom Out Detail, create slide shows of their digital photos, they save them to a CD, flash drive or memory card or other device.

In one embodiment, a user can view videos or watch movies on this digital photo album any where any place because it's portable. It can have WiFi and other wireless capabilities as described above. The album can also include the ability for a user to check stocks, weather, Internet, web sites, have a calendar, time and date, etc.

The areas where the user touches to operate the unit can be any icon or design known now or developed in the future. The screens can be LCD or any type known or developed in the future. The areas where the inside of the album closes and touches can have rubber or plastic pads molded or snapped together, so the two surfaces don't scratch each other. In addition, it is contemplated to have a built in light for the storage area or for the display screens.

### Typical Operation

The digital photo album is like a book. In one embodiment, the user opens it up, turns the power on. Once the unit is on, then the right screen in a dual-screen embodiment would be the primary screen to view the options for the user. This would be the navigation screen or the desk top like a computer. The user can download pictures to the built-in memory or memory expansion cards via cell phone, computer, laptop, camera or any electronic device. The user can also download pictures to the built-in memory or memory expansion cards via inserting a memory card. The album can have windows that appear on the screen to help the user navigate to make their choices. Once a device or memory card is connected, then an indicator would appear on the screen showing a device is connected, then it can give the user options to download pictures or to view them only. There can be a status bar showing images being transferred, just like a computer does. Most of this process is just like when a user connects a memory card to a computer or laptop, the laptop or computer identifies a connection and gives you options of what you want to do with the pictures. There would be more options like 3″×5″ or 4″×6″, full size, slide show, where it automatically shows photos, but the user would have the option to push previous or the back button or forward etc. In another embodiment as described above, the digital photo album would have one LCD screen on the right inside area, a storage area on the left inside with a possible picture insert area.

The user can connect a device mentioned above or insert a memory card to download images. After the images are downloaded, then the user could be given the option to delete them off the card, camera or any electronic device. Then the user can view images off the device. The user would be given the option to view images without downloading them. The user can open the back cover or where ever the storage area is located and, get a memory card out of the storage area, close the storage door, and insert the memory card into the port opening. Then the unit would sense that there is a memory card attached, then the unit would give the user options to choose. If the device is plugged in like a camera and another memory card is inside a port or all ports are filled with a memory card or cord, then the unit must be capable of showing them on screen, so the user can decide which one to view.

After viewing the user can have the option to close out of those images and once the user closes out, then the user could see what is still available for viewing and what ports are attached and have photos, along with the built in memory choices. After the user doesn't want to view the current photos, there can be an easy way for the user to close out and get back to the main desktop to see what else is available for viewing. The main desktop can contain icons that are generated every time a user downloads images, so the user will see what they can view. There can be a system to identify in number, name or letter sequence the images that are in the built-in memory. Every time the user downloads images, there should be a way that the new images are identified separately. Otherwise every time the user goes to view images they would have to view all images until they get to what they wanted to view. One option is every time they download images, they can identify them using a keypad on the main desktop and scroll up down and select etc. The user can shut the unit off by on screen selection like a computer has, touch screen, touch border or just push the on and off button.

In one embodiment, a unit is designed for viewing digital photos only on a hand held portable device. The user would have more options than a computer or laptop. The album can rotate photos to the right or the left. There can be a smaller version and a bigger version. The smaller version can have 1 or 2—5″×7″ LCD screens and the larger version can have 1 or 2—8″×10″ or 1 or 2—8 1/12″×11″ LCD screens. Other dimensional variations are possible. There is a systematic way for images to fit on the LCD screen; it all depends on the main size of the LCD and the size photos the user wants to view. If the user selects full screen, then the CPU would process the full screen images on the LCD screen provided. The user can decide to choose 3″×5″ or 4″×6″ or the right size that can fit onto the LCD screen appropriately. If the user decides to choose 3×5 or 4×6 then the CPU would generate photos in that size and in the order they are on the built-in memory or memory card. It all depends on the size of the LCD screen. Another factor is whether it is a vertical or horizontal picture, the size of the LCD screen. Horizontal and vertical pictures all determine how many pictures can fit onto the screen. Most people will probably view pictures in full screen because it's a fast and easy and you can see full size pictures which are easy to view everyone and everything in the picture. However when you blow up images to big then it can distort the photos and this is why some people will not like to view all photos bigger than 5×7 all the time. The resolution will play a big factor; if the resolution is good then many big photos still look good. If the user decides to use full size 5×7 or 8×10 and a vertical picture is present, then the sides would crop and show black to compensate for the vertical size. While viewing photos the user can push the previous button, back button or forward button to advance photos. If the user selects slideshow, then it automatically does it for them.

After viewing all photos then the image would go to the beginning of the photos until they exit the photos. Just like viewing pictures on a laptop. There would also be speakers built in (5718; FIG. 57, for example). There would also be a place to plug in a speaker and head phones.

In one embodiment, when photos are generated and arranged by the CPU and if the user chooses full screen, then the 1st photo would appear to the left and the 2nd photo would appear to the right and after they push next, then the 3rd photo would appear to the left and the 4th photo to the right and so forth. If the user picks 4×6 for example and the LCD screen can hold 6—4×6 photos horizontal, then photos 1-6 appear on the left and 7-12 on the right and if the user hit's the next button then the next 6 photos would appear left and the right. If there are vertical pictures, the LCD screen would show vertical and horizontal pictures and it might add up to be 4 photos on the page, then the next images in order would appear on the LCD screen. It's possible to have a LCD screen that can hold 5×7 horizontally and vertically only and an 8×10 horizontally and vertically. Or an LCD screen that holds 5×7 vertically and crops when there's a horizontal picture or a LCD screen that holds a 8×10 vertically and crops when there's a horizontal picture. In another embodiment there would be one LCD screen on the inside right or left and a storage area with possible picture insert on the left or right inside area. In this embodiment, it would work as mentioned in an embodiment described herein, but the images and video would appear on one LCD screen. So, for example, if the user clicks full screen images, then the first image would appear on the screen and when they click next, then the next image would appear. If the user clicks 3×5 or 4×6, then the first 3×5 or 4×6 images would appear on the screen and when they click next then the next images would appear on the same screen and so forth.

### Alternative Typical Operation

In one non-limiting example, for a dual-screen digital photo album embodiment, a user will power on the unit and then the album will play a slide show of pictures, etc., resident in a built-in flash or inserted memory card in full-screen or four-picture mode. This mode can be changed in the preferences or options menu. During the slide show viewing, if it is desired to switch picture modes, then a user simply needs to press the Enter key and will toggle between full-screen and four-picture mode, for example. The Left and Right keys can be used to advance photos forward or backward, and the Up key may be used to pause the slide show and then re-start the slide show out of a pause operation. By pressing a Menu button, a user is able to select options such as Copy, Delete, Rotate, Enlarge, Display Properties, etc., and then pressing Menu again will resume the slide show. If it is desired to listen to music, then the user needs to select Music from a Menu operation or select a Music icon as the case may be, wherein a submenu may pop up with the options of Playing, Album, PlayList, Volume, Folder, etc. Also provided could be a Video menu for selecting and playing videos. The Menu feature also provides the ability to set preferences and settings such as Language, Date/Time, Contrast, Color, Slideshow, etc.

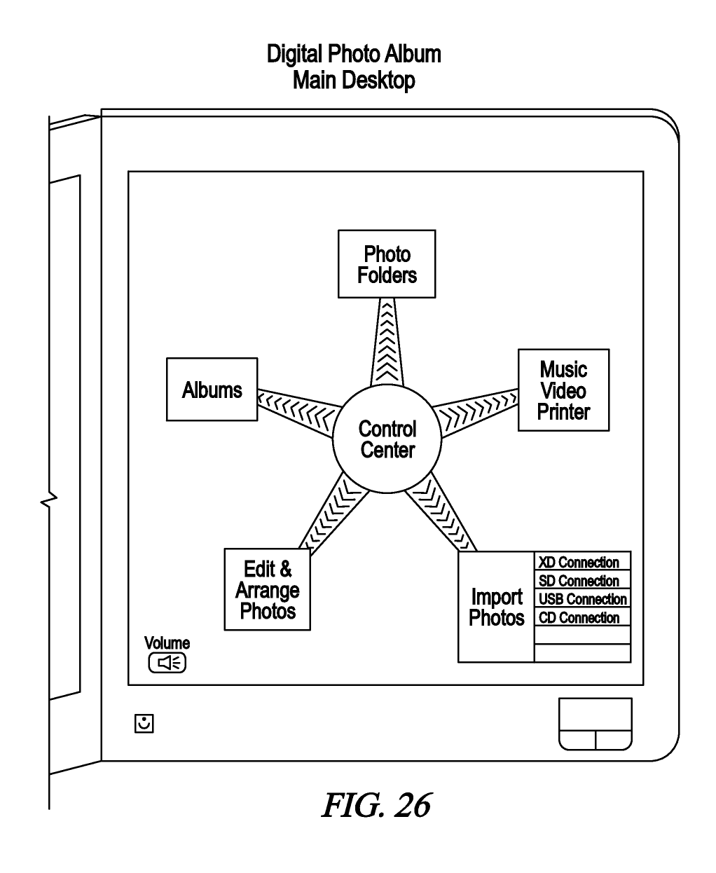

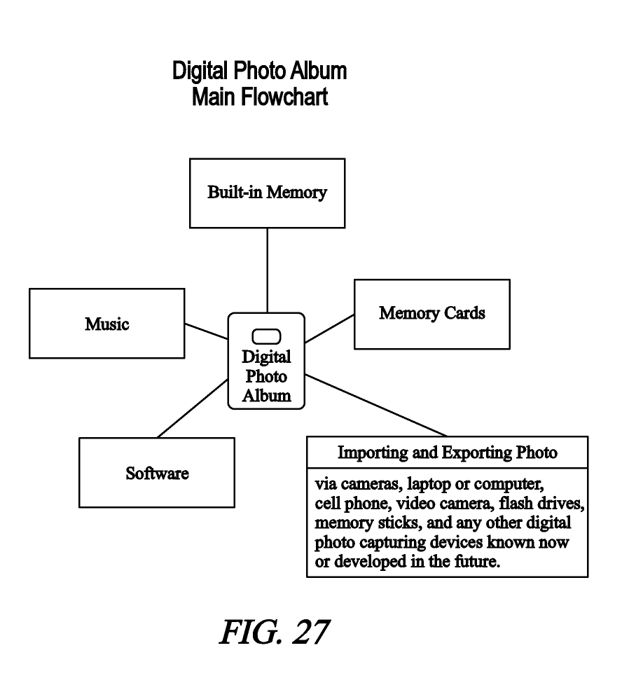

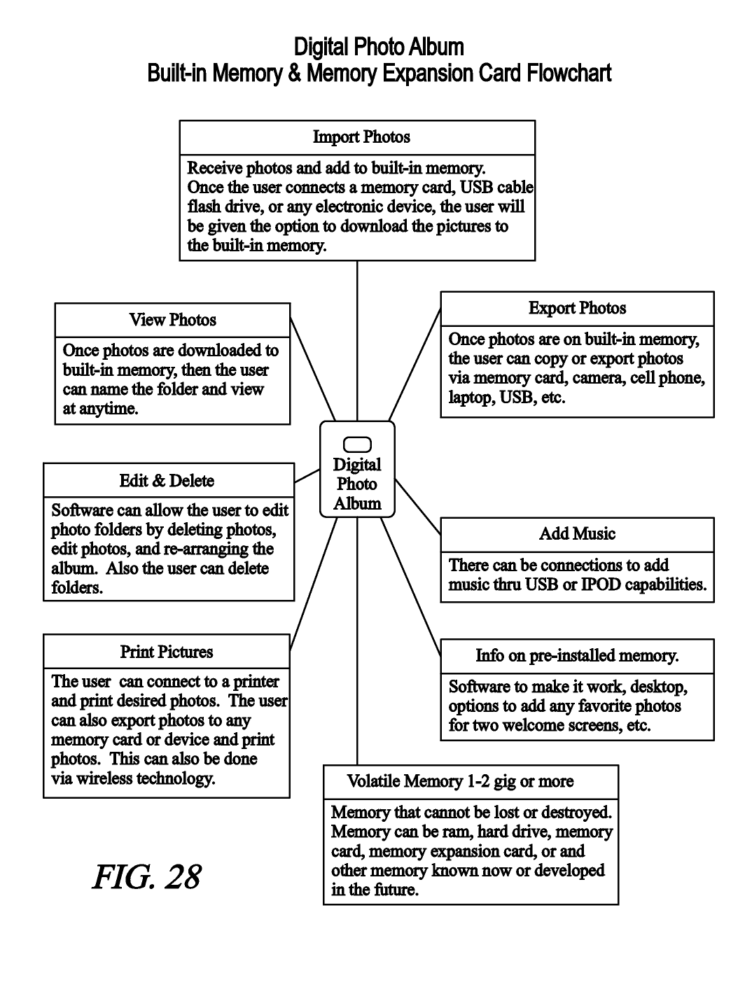

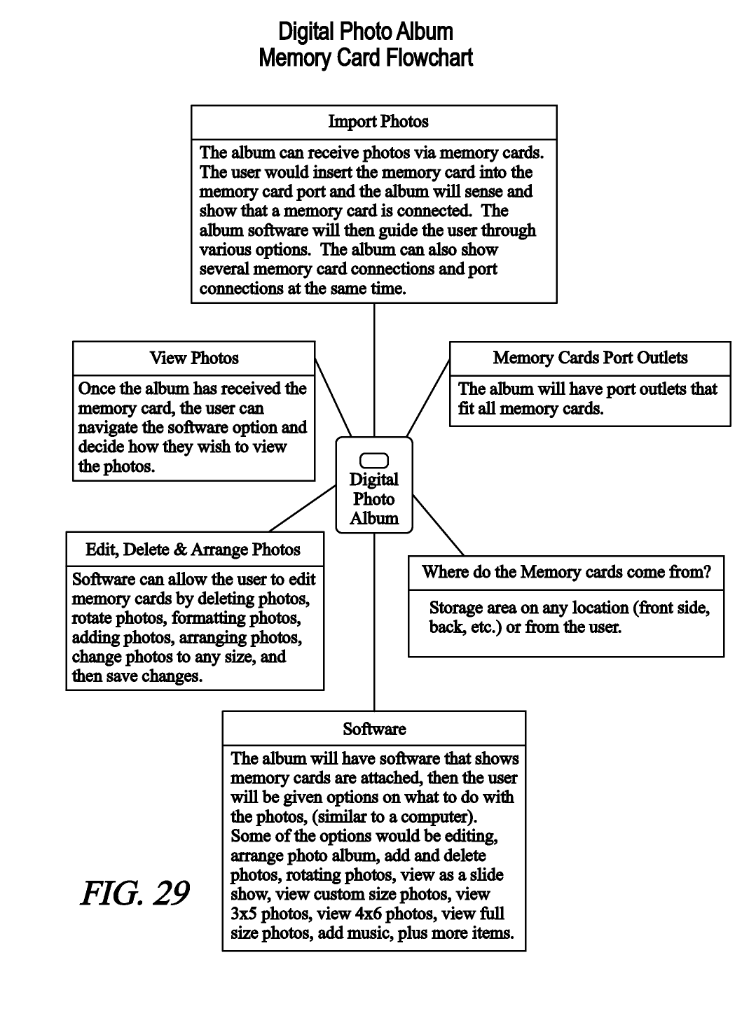

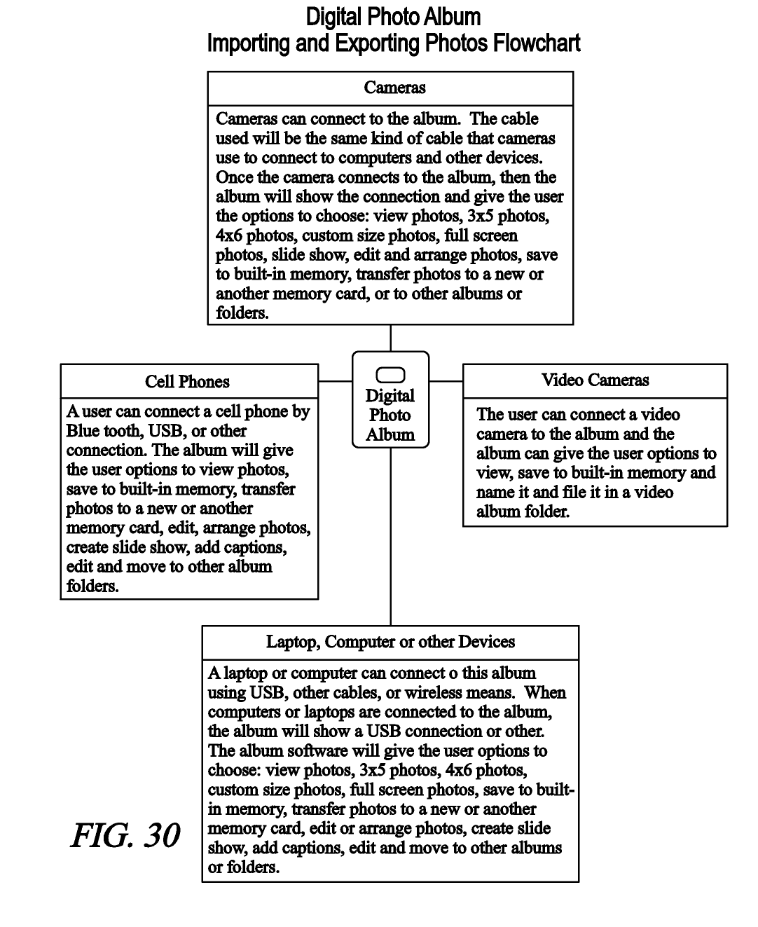

### Possible Screen Window and Functions (FIGS. 26-30)

Any type of window function is available, but the following represents some non-limiting examples.

A main desktop or main screen can be on the left or right LCD screen or just on one screen for the one screen digital photo album version and can have icons, folders or other, any where on the page. For example, as shown in FIG. 26, there can be icons like control panel, Albums, Photo Folders, Edit and Arrange Photos, Import Photos, Music, video, and printer. On the import photo icon, bars could pop up or light up that show port connections, like XD, SD, CD and USB connections. They would light up when there was a connection to these ports. The operation can be made through buttons, touch screen, touch border technology or any way known now or in the future.

One embodiment of a simple version of a digital photo album can be developed where the photo album can view photos when memory cards, USB, or any other port is connected with digital photos. It can have no music capabilities, no video capabilities, and no wireless capabilities. It can have a storage area for memory cards and other digital photo saving devices. The storage area can be located anywhere on the cover or anywhere within the digital photo album. The storage area can be like any way mentioned in this application or what is known today or developed in the future. There can be easy software to view photos. Windows can show view photos and if the user clicks it then the options like view 3×5, view 4×6, view full screen, view slide show. If the user clicks the bar or window of choice, then the CPU will generate these photos as the user requested. The first set of photos would appear on the left LCD screen and the second set of photos would appear on the right LCD screen. Then if the user clicks the next button the third set of photos would appear on the left LCD screen and the fourth set of photos would appear on the right LCD screen and so forth. The user can click previous buttons or forward buttons to move the pages if desired. At the end of the photos, it can return to the beginning photos and the user click the exit button to exit. In another embodiment, a one screen version can be used and the user would be viewing all images and video on one screen. When the user chooses full screen, 3×5, 4×6 or other, then the images would appear on the one screen and when the user clicks next the next set of images would appear on the same screen. The user can click previous buttons or forward buttons to move the pages if desired.

One embodiment of a control center window can have non-limiting folders or icons and their function as follows: Background or set Picture—user can select photo, custom or color backgrounds; Screensaver-user can select screensaver photo or other; Music—if the user clicks this, then it gives the user options to listen or download music; Videos—if the user clicks this it will take them to the video area; Date and Time—the user can select current date and time zones; Memory—if the user clicks this, it can give them how much memory is used and what is available in the built in memory and memory expansion areas. Once the built-in memory area is full and the user wants to download more photos to the expansion ports, then the system will automatically tell the user which port the photos are going to. Every photo album once downloaded will have indicators where they are located. The digital photo album can have memory card or other devices for backing up the built-in memory. In the storage area, there can be a place where these can be placed. The digital photo album software can be designed to remind the user to back-up any time they make changes or any time. This feature is very important, because with any electronic device there is always a chance of failure. And if the user backs up when they should, then the user will have peace of mind knowing all their photos, videos will not be lost.

Other non-limiting control functions can include: Album—takes the user back to the album window or page; Photo Folder—takes the user back to the photo folder window or page; Edit and Arrange—takes the user back to the edit and arrange window or folder; Import Photos—takes the user back to the import photos window or folder, which can have icons, or bars or other like video connection, SD connection, XD connection, USB connection, CD connection, or any known now or developed in the future. When there's a connection to the port, then the bar or icon can light up, flash or any other notifying way. The user can click the icon or bar type connection and then window can give the user options like.

Other non-limiting control functions can include: Home—takes the user back to the home page; View Photos—takes the user to view photos window and it give the user choices on how they would like to view the photos; Save to Album—gives the user options to save and keep photos on built-in memory or make changes and keep all new changes and or photos on a memory card, so it's ready to view later; Save to Photo Folder—takes the user to the photo folder window; Memory—takes the user to the memory window where the user can view how much memory is used and what is available in built-in memory and memory expansion ports.

In addition, when a user clicks the Album window, then it takes the user the album page where all the album folders appear. At the top or anywhere, it can give the user instructions like; Click folder once for options or the user could for example, right click the folder and bars would appear like; Create Album—View as a slide show—View album. Underneath the folders it can have captions explaining what's in the photo folder. Where ever it says right click, left click or double click in this application, there can be any possible way of doing this known now or developed in the future.

When the user clicks or chooses the view or view as a slide show, then the screen changes and all photos that are in the album appear. The first page of photos appears on the left LCD screen and the second page of photos appears on the right LCD screen. When the user clicks next, the third page of photos appears on the left LCD screen and the fourth page of photos appears on the right LCD screen. If the user clicks the back or previous button, then the previous pages appear on the left and right LCD screens. If the user clicks slide show, transitional effects or any type of digital photo viewing, then the photos will automatically start appearing and changes pages every 10 seconds or at a time established by the user in the settings or preferences section of the setup. If the user clicks previous or forward during slide show viewing or other, then the pages will go back or forward. In another embodiment, a one LCD screen version can be used where photos and video would appear on one LCD screen. The next pages and previous and back buttons would allow these pages to appear on the same screen instead of the left and right screen described above.

If the user right clicks any folder, then in one embodiment the user will have the option to see and click the following non-limiting options; Create Album, Edit and Arrange, Import Photos, Export Photos, Send To, Add Photos from Photo Folders, Multi-Transitional Effects, Zoom in Detail and Zoom out Detail, or other. If the user clicks the Create Album, then all pictures appear on the screen and instructions at the top can say, for example, first step arrange photos, second step edit photos, third step save photos, and fourth step finish. A user can also click a music icon or in the tool bar for easy access to music.

If the user clicks albums or photo folders, then either all album folders would appear or all photo folders would appear below. With respect to the Folders option, the digital photo album software can allow the user to name the folders, so the user can identify what's inside the folder, like “2008 Vacation.” Then if the user clicks the album or photo folder, it would open up and all photos would appear at the top of the screen. If the user right clicks any folder options like arrange photos, create slide show, send to my photos, any location or export photo, a particular folder, delete, create album etc. If the user clicks the folder once or twice all photos would appear on the page or screen. Above the photos or anywhere, there can be options like arrange photos, edit photos, create slide show Multi-Transitional Effects, Zoom in Detail and Zoom out Detail. If the user clicks the arrange photos, the user could move photos by click and drag to the desired locations. If the user right clicks any photo, the user will have the option to delete photo, rotate left, rotate right, make custom size photos, make 3×5 photos, make 4×6 photos, add or delete captions, make full size photo, Multi-Transitional Effects, Zoom In Detail and Zoom Out Detail. Send To; my photos, any location or export photo, to a particular folder.

If the user selects or clicks create album, the all photos would appear on the page or screen. The primary screen can be the right or left screen, or one screen in the one screen version. The first step would show arrange photos and click and drag photos to arrange in desired locations. Second step, right click photo to delete photo, rotate left, rotate right, make custom size photos, make 3×5 photo, make 4×6 photo, add or delete captions, make full size photo, Multi-Transitional Effects, Zoom In Detail and Zoom Out Detail, Send To; my photos, any location or export photo, to a particular folder, third step click finish, create or done.

The user can click View Photos or View as a Slide Show and the user view photos or view as a slide show and the first set of photos would appear on the left LCD screen and the second set of photos would appear on the right LCD. If the user double clicks the photo folder or the album folder it can automatically open all photos in the folder. If the user right clicks any folder it will give the user options like arrange photos, create slide show, send to my photos, any location or export photo, to a particular folder, delete, create album, Multi-Transitional Effects, Zoom In Detail and Zoom Out Detail, etc. In a one LCD screen version, the first set of photos would appear on the one screen and when they click next, and then the second set would appear on the same screen and so forth. If the user wants to send a photo folder to a particular place like an album, the user can have a screen or window pop up. When the user clicks the bar it can say, “Look In:” and then the user can seek a particular album that they would like to send the photos to. If the user selects Send To, then a bar can show up and the user can have an option to send it SD port, XD port, USB, or other. A screen can show that pictures are ready for export and if the user clicks it, then the user can have instructions to transfer the photo or folders to the port of their choosing. Every window can have icons or just spelling of the window pages and if the user clicks it, then it will take them to that page, just like web site pages operate.

There can be a video memory card, or any type of video capturing device known now or developed in the future that is permanent or removable in the digital photo album. The videos can be saved in the built-in memory or just view only and can be transferred in and out of the photo album or on to memory cards, devices or video cameras. When there's a video connection a bar or icon can, for example, light up NEW VIDEO CONNECTION. Once the user clicks on this bar then the option or bars might appear like; SAVE TO VIDEO FOLDER (If the user clicks this folder, it will give the option to name it), OR OPEN AND VIEW VIDEO ONLY (After viewing, it can give the user options to save to the video folder, if not it will not erase the video from the camcorder or any device where it was connected to the album.). Below this area, there can be all the video folders with captions describing the folder. If the user clicks VIEW VIDEO ONLY, then the video will start playing on the right side (Can have options to choose right or left LCD screen). After the video is finished a window will show up asking to save to video folder or to disconnect. The user can have the option to view one photo, slide show, or album on the left LCD screen while viewing a video on the right LCD screen. One display/LCD screen version can have a small window and can play video and have pictures on the bigger window of the screen or vice versus. If the user clicks the video folder, then it will give the option or a bar will pop up or appear that can show View Video or Send To. If the user right clicks the folder then it can show Send To, Export, Add or delete captions.

Music Window. When a device like an iPod is attached a window can appear or a flashing area in the tool bar indicating a new music connection. If the user clicks on this, then the digital photo album can start playing music or a bar or option can appear like Add to Music Folder or Listen Only. If the user clicks on a music folder, then the user can play their favorite songs. The digital photo album can have ipod capabilities like the typical ipod stands or platforms and the user can listen thru the built-in speakers. The user can also listen to music thru an ear piece plugged into the ear piece port. For easy access to music, there can be an icon for music in the tool bar or any where out of the way so the user can control volume and choose their favorite music.

The digital photo album as described herein should be compatible with all type of memory cards like Compact Flash, CF-Type 1, CF-Type II, CF-Ultra II, Microdrive, SD, SD-Ultra, SDHC, SDC, mini SD, MMC, HS-MMC, RS-MMC, Memory Sticks, MS, MS(MG), MS-Pro, HS-MS-Pro, MS DUO, MS-Pro Duo, HS-MS-Pro Duo, SM, XD, T-Flash, any type known now or developed in the future and the like. Furthermore, it should be compatible with JPG, TIF, GIF, AVI, MPEG-1, MPEG-2, MPEG-4, Files and MP3 or WMA music files and any known now or developed in the future. Yet it should also compatible with Apple, Windows 2000, Windows XP, Vista Windows CE, Linux system, and any other operating or window type system or software, computer software, digital photo software, digital photo viewing software known now or developed in the future.

The digital photo album may have pre programmed or pre installed sales pictures, sales video or instructional materials. This would be designed for in store sales and marketing, where the digital photo album would be open and placed on a shelf, counter or anywhere so the viewer or potential customer can see how the digital photo album works. It may also have a digital user agreement which needs to be read and accepted by the user before using.

While the present invention has been described at some length and with some particularity with respect to the several described embodiments, it is not intended that it should be limited to any such particulars or embodiments or any particular embodiment, but it is to be construed so as to provide the broadest possible interpretation in view of the prior art and, therefore, to effectively encompass the intended scope of the invention. Any design can be used along with any type of storage area, any type of screens, any type of function, any type of software having to do with viewing digital photos, known now or developed in the future. Furthermore, the foregoing describes the invention in terms of embodiments foreseen by the inventor for which an enabling description was available, notwithstanding that insubstantial modifications of the invention, not presently foreseen, may nonetheless represent equivalents thereto

I claim:

1. A digital album comprising:
a) a first location for storing digital media; and
b) a second location for viewing the stored digital media;
c) wherein the first and second locations are connected together and are movable relative to each other from an open orientation to a closed orientation, wherein the closed orientation assumes the appearance of a book-like photo album.

2. The digital album of claim 1, wherein the first location further comprises storage for a plurality of digital media.

3. The digital album of claim 2, wherein the storage for a plurality of digital media further comprises a plurality of rows of storage locations.

4. The digital album of claim 2, wherein the first location further comprises a storage cover for covering the plurality of digital media, the storage cover further comprising a pocket that faces the second location when the album is in the closed position.

5. The digital album of claim 1, the second location further comprising a digital viewing unit for displaying digital media stored in the first location.

6. The digital album of claim 5, wherein the digital viewing unit further comprises a plurality of viewing regions for viewing a plurality of digital media objects on the digital viewing unit at a given time.

7. The digital album of claim 5, further comprising touch navigation buttons associated with the digital viewing unit for navigating through digital media displayed on the digital viewing unit.

8. The digital album of claim 1, wherein each of the first and second locations has an inner facing side and an outer side, and wherein one of the outer sides of the first and second locations further comprises a sleeve or pocket for removably receiving material therein.

9. The digital album of claim 1, wherein the first location further comprises an inner side facing the second location, and an outer side, and wherein the outer side further comprises an access door for accessing the stored digital media.

10. The digital album of claim 9, wherein the second location further comprises a first digital display unit and the inner side of the first location further comprises a second digital display unit.

11. The digital album of claim 1, further comprising a removable memory port for receiving a removable memory device.

12. The digital album of claim 1, further comprising a remote control port for communicating with a remote control device.

13. The digital album of claim 1, wherein the digital media further comprises photographs, movies, videos, music or combinations thereof.

14. A method of viewing digital media on a digital album, comprising:
a) providing a digital album having a first location connected to a second location, wherein the first and second locations are movable relative to each other from an open orientation to a closed orientation, wherein the closed orientation assumes the appearance of a book-like photo album, the digital album further comprising a storage location associated with at least one of the first and second locations for storing digital media, and at least one display associated with at least one of the first and second locations for displaying digital media stored in the storage location,
b) moving the digital album from the closed orientation to the open orientation,
c) inserting a removable digital media device into the digital album, and
d) viewing, on the at least one display, digital media stored on the removable digital media device.

15. The method of claim 14, wherein the display is associated with one of the first and second locations and the storage location is associated with the other of the first and second locations, such that the display and storage locations are movable relative to each other from an open position to a closed position.

16. The method of claim 14, further comprising a first display associated with the first location and a second display associated with the second location.

17. The method of claim 14, further comprising selecting a plurality of digital media viewable at one time on the display.

18. A digital photo album comprising:
a) a first display unit hingedly connected to a media storage compartment and movable relative to each other from an open orientation to a closed orientation, wherein the closed orientation assumes the appearance of a book-like photo album, the first display unit for displaying media stored in the storage compartment,
b) the first display unit further comprising a removable memory port for receiving a removable memory device that is capable of being stored in the media storage compartment,
c) the first display unit further comprising a navigation control system for navigating through media being displayed on the first display unit, and
d) the first display unit adapted for displaying a range of at least one digital photo to a plurality of digital photos at a time.

19. The digital photo album of claim 18, further comprising a second display unit associated with the media storage compartment, the second display unit facing the first display unit in the closed orientation, the media storage compartment disposed on the back of the second display unit and facing away from the first display unit.

20. The digital photo album of claim 18, wherein the first display unit displays four digital photos at a time.
